(19) United States
(12) Patent Application Publication
(10) Pub. No.: US 2009/0221280 A1
(43) Pub. Date: Sep. 3, 2009

(54) PERSONALIZATION SYSTEM AND METHODS

(75) Inventor: Julien Mitelberg, New York, NY (US)

Correspondence Address: GREENBERG TRAURIG, LLP, 2101 L Street, N.W., Suite 1000, Washington, DC, 20037, US

(73) Assignee: Cellfish Media, LLC, New York, NY (US)

(21) Appl. No.: 12/395,274

(22) Filed: Feb. 27, 2009

Related U.S. Application Data
(63) Continuation-in-part of application No. 12/016,240, filed on Jan. 18, 2008.
(60) Provisional application No. 60/885,642, filed on Jan. 19, 2007.

(51) Int. Cl. H04M 3/00

(52) U.S. Cl. 455/418

(57) ABSTRACT

The systems and methods of the present invention project media content associated with a user to devices of a group of the user's friends. Such devices may be web-enabled and/or cellular telephones. The user's information and a list of friends are received from a user via a network and stored in a database. The user information is distributed to the friends' phone. Media content may also be distributed. The media content may include an image, a video, an avatar, or a ring tone. The media content may be stored on a friend's phone so that the media content is played when that phone receives an incoming call from the user. The invention allows users to set the way they will be identified on their friends' phones, even if they don't have that particular media content. Accordingly, a cellular telephone or other web-enabled device can be further personalized.

This application is a Continuation-in-Part of and claims priority from U.S. patent application Ser. No. 12/016,240, filed Jan. 18, 2008, entitled “Telephone Personalization System and Methods”, which claims priority from Provisional U.S. Patent Application Ser. No. 60/885,642, filed Jan. 19, 2007, both of which are hereby incorporated by reference in their entirety. This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The instant disclosure relates to the field of customizing devices and, more specifically, describes a system and methods through which an web-enabled device and/or cellular telephone can provide individualized forms of expression.

### BACKGROUND

Web-enabled devices, such as cellular telephones, are an increasingly prevalent part of society. They permit people to remain in contact through a variety of means, including more traditional voice conversations, as well as through Instant Messaging (“IM”) and Short Message Service (“SMS”) messages and attachments thereto.

As cellular telephone coverage improves and cellular telephones begin to support alternative communications means, such as, without limitation, those based on voice over Internet Protocol (“VoIP”) technology, users are becoming increasingly reliant upon their cellular telephones. As a result of the increased usage necessitated by this reliance, users are also becoming more interested in personalizing their phones. For example, some users assign specific ring tones to individual contacts in the telephone's address book, thus permitting them to easily identify the caller associated with an incoming call. Some users even create and/or download additional ring tones.

A recently introduced personalization feature is what is generally referred to as a “ring-back” tone. A ring-back tone is a sound, song, or the like that is played when a caller is attempting to contact a particular user. By way of example, if Joe's mother attempted to call Joe, Joe's mother would hear the ring-back tone Joe selected. In some cases, the ring-back tone can be caller-specific, much like a ring tone.

### SUMMARY

The personalization system described herein permits the user to define social networks (alternatively referred to herein as “tribes”) and to project and receive information, including a mood, to members of such social networks or to individual contacts. Users can select from a set of pre-defined attitudes, images, avatars, videos, ring tones, and other attributes to be projected, and can add or create their own attributes and/or purchase additional attributes to further facilitate personalization.

An embodiment of the personalization system and method comprises a method of projecting information about a first user from a first device associated with the first user to at least one device associated with a first group of friends, including receiving from the first user a first set of contacts, wherein each contact in the first set of contacts has device contact information associated therewith; storing the first set of contacts in the first device associated with the first user; permitting the first user to define the first group of friends, wherein the first group of friends comprises members of the first set of contacts; storing the first group of friends; and, receiving from the first user personal media to be projected to the first group of friends. The personal media may be stored in a file locker. Some embodiments also include the steps of retrieving the device contact information from the first set of contacts for each member of the first group of friends; and transmitting the personal media from the file locker to the first group of friends.

An embodiment may include the scanning of the personal media for digital rights management information; and, determining whether transmitting the personal media complies with the digital rights management information. Some embodiments include the step of receiving from at least one device associated with the first group of friends a confirmation that the personal media has been received.

In some embodiments, the first device may be any web-enabled device. In certain embodiments, the first device may be a telephone, such as, without limitation, a cellular or mobile telephone. Further, in some embodiments, at least one device associated with a first group of friends may be a web-enabled device and/or a telephone, such as, without limitation, a cellular telephone.

In some embodiments, the device contact information may comprise a Uniform Resource Locator (“URL”); a network address, such as, without limitation, an Internet Protocol address, a Machine Access Code (“MAC”) address, or the like; and/or a telephone number. In some embodiments, the information may comprise text, a static or animated picture, a ring tone, or the like.

In some embodiments, the personal media may be caused to associate with the first user within at least one device associated with a first group of friends. In certain embodiments, the method includes the step of synchronizing the personal media with a contact list or an address book within at least one device associated with a first group of friends. The step of associating/synchronizing the media/information with the user comprises causing the information to be stored as part of a contact list entry in the device. By way of example, without limitation, where the information comprises an image, the image may be substituted for or included with any image currently associated with the user in the device's contact list.

In some embodiments, the information is presented when the device is contacted or receives a message, such as a telephone call, e-mail, SMS, MMS, EMS, IM, or Push-To-Talk (PTT). By way of example, without limitation, the device may: display the image, picture, or avatar; play the ring tone; or play the video, as appropriate, when the device receives an incoming call from the user.

In some embodiments, the method may further comprise identifying as a second device any device associated with a member of the first group of friends that is not capable of utilizing the information and facilitating the installation of software on the second device such that the second device is capable of utilizing the information.

In some embodiments, the information may be transmitted to the device using SMS, HTTP, HTTPS, UDP, Socket, SIV, SIP, SIC or other such communications protocol.

In some embodiments, the first group of friends may be stored remotely from the first device, thereby allowing the user to easily modify the first group of friends via a World Wide Web site or the like, without having to incur additional charges on his or her cellular telephone bill, and without needing to have the first device present.

In some embodiments, the first group of friends may comprise one or more entries. By way of example, without limitation, although the method is generally described as applying to a plurality of friends, the method can be readily applied to a single friend, such that the user can convey mood and other information to that individual.

In some embodiments, the information may comprise at least one color. By way of example, without limitation, the device cause any fonts used when displaying information about the user to be displayed in the color; the device may cause the background color of a contact list entry for the user to match or reflect the color; or the device may cause the screen to utilize the color as a background color for any SMS messages received from the user or when a call is received from the user.

In addition, an embodiment may comprise a method of projecting information about a first user from a first telephone associated with the first user to at least one telephone associated with a first group of friends, comprising: receiving from the first user a first set of contacts, wherein each contact in the first set of contacts has at least one telephone number associated therewith; storing the first set of contacts in the first telephone associated with the first user; permitting the first user to define the first group of friends, wherein the first group of friends comprises members of the first set of contacts; storing the first group of friends; receiving from the first user personal media to be projected to the first group of friends, the personal media being stored in a file locker, the file locker located on the client server; retrieving the telephone contact information from the first set of contacts for each member of the first group of friends; transmitting the information from the file locker to the first group of friends.

Some embodiments also include the steps of scanning the personal media for digital rights management information and determining whether transmitting the personal media complies with the digital rights management information. Certain embodiments also include the step of receiving from at least one device associated with the first group of friends a confirmation that the personal media has been received. An embodiment may include identifying as a second device any device associated with a member of the first group of friends that is not capable of utilizing the personal media and facilitating the installation of software on the second device such that the second device is capable of utilizing the information.

Some embodiments may include associating the personal media with the first user and/or synchronizing the personal media with a contact list and/or address book. In some embodiments, the first device may be any web-enabled device. In certain embodiments, the first device may be a telephone, such as, without limitation, a cellular telephone. Further, in some embodiments, at least one device associated with a first group of friends may be a web-enabled device and/or a telephone, such as, without limitation, a cellular telephone. Some embodiments include the step of causing the telephone associated with each member of the first group of friends to associate the information with the user.

In an embodiment, the method of projecting information onto a device includes receiving user information and a plurality of contacts, wherein the user information and the plurality of contacts are received from a user via a network, wherein the user information has user device information associated with the user, and wherein each contact of the plurality of contacts has device contact information associated therewith; storing the user information and the plurality of contacts in a database, wherein the database is accessible to the network; distributing the user information to a plurality of devices via the network, wherein the plurality of devices are identified by the corresponding device contact information associated with the plurality of contacts; and, storing the user information in the plurality of devices.

Certain embodiment further include distributing media content to the plurality of devices; storing the media content in the plurality of devices; and, associating the media content with the user within the plurality of devices.

In some embodiments, the media content comprises at least one media content selected from the group consisting of: an image, a video, an avatar, and/or a ring tone. The user information may include media information associated with the user. The media information may also be associated to the user within the plurality of devices. Further, the media information may be an alert that notifies one of the plurality of devices of an incoming communications from the user.

In certain embodiments, the media information may be associated to at least one media content selected from the group consisting of: an image, a video, an avatar, and/or a ring tone. The media content may be stored on the plurality of devices.

In embodiment, the media content may be accessible via the network. Further, the embodiment may include distributing the media content to the plurality of devices and storing the media content in the plurality of devices.

Some embodiments include the steps of associating the media content with the user within the plurality of devices. Embodiments may include the step of synchronizing the media content with the plurality of contacts or with an address book. In some embodiments, at least one of the plurality of devices may be web-enabled and/or cellular telephones.

Moreover, certain embodiments provide a system for projecting information onto devices including user information and a plurality of contacts received from a user via a network, wherein the user information has user device information associated with the user, and wherein each contact of the plurality of contacts has device contact information associated therewith; a database accessible to the network, wherein the user information and the plurality of contacts are stored in the database; and, a plurality of devices accessible via the network, wherein the plurality of devices are identified by the corresponding device contact information associated with the plurality of contacts, and wherein the user information is distributed to the plurality of devices and stored therein. The media content may be accessible to the network, wherein the media content is distributed to the plurality of devices.

In some embodiments, the media content may be associated with the user within the plurality of devices. For certain embodiments, the media content may be synchronized with the plurality of contacts or with an address book. Furthermore, at least one of the plurality of devices may be web-enabled devices and/or cellular telephones in some embodiments.

In another embodiment, the personalization system and method comprises of a method of receiving information from a friend associated with a user, including: permitting the friend to transmit media, wherein the media is to be projected on a device associated with the user; receiving from the user a request to transmit the media; permitting the friend to select personal media; selecting the personal media to be transmitted; and receiving the personal media from a device associated with the friend.

Certain embodiments also include storing the personal media in a file locker. Some of the embodiments further include transmitting the personal media from the file locker to the device associated with the user. Some embodiment include projecting the personal media on the device associated with the user.

An embodiment may include associating the personal media with the friend on the device associated with the user. Another embodiment may include synchronizing the personal media with an address book within the device associated with the user. In some embodiments, the device associated with the user may be a web-enabled device. In certain embodiments, the device associated with the user may be a telephone, such as, without limitation, a cellular or mobile telephone.

It is to be understood that both the foregoing general description and the following detailed description are exemplary and explanatory and are intended to provide further explanation of the disclosed personalization system and methods.

### BRIEF DESCRIPTION OF THE DRAWINGS

The accompanying drawings, which are included to provide a further understanding of the disclosed personalization system and methods and are incorporated in and constitute a part of this specification, illustrate various embodiments and, together with the description, serve to explain the principles of at least one embodiment of the disclosed personalization system and methods.

In the drawings:

FIG. 1 is a simulated traditional cellular telephone, including a screen.

FIG. 2 is an example of a contact list on a cellular telephone on which the disclosed telephone personalization system and methods have been installed.

FIG. 3 is diagram illustrating an example of a system architecture for providing a telephone personalization system and methods according to an embodiment.

FIG. 4 is an example of an introductory user interface.

FIG. 5 is an example of a tribe information entry user interface.

FIG. 6 is an example of a tribe picture selection user interface.

FIG. 7 is an example of a tribe attitude selection user interface.

FIG. 8 is an example of a mood/attitude picture selection user interface.

FIG. 9 is an example of a tribe creation confirmation user interface.

FIG. 10 is an example of a tribe member selection user interface.

FIG. 11 is an example of a tribe membership invitation user interface.

FIG. 12 is an example of a SMS message that facilitates installing software that facilitates the disclosed telephone personalization system and methods.

FIG. 13 is an example of a user interface through which a user initiates the installation of software that facilitates the disclosed telephone personalization system and methods.

FIG. 14 is an example of a user interface that is displayed as the disclosed telephone personalization system and methods are downloaded and installed on a cellular telephone.

FIG. 15 is an example of a tribe control confirmation user interface.

FIG. 16 is an example of a tribe mood change user interface.

FIG. 17 is an example of a tribe mood change confirmation user interface.

FIG. 18 is an example of an individual contact menu.

FIG. 19 is an example of an individual contact mood selection user interface.

FIG. 20 is an example of an individual contact mood selection confirmation user interface.

FIG. 21 is an example of a user interface through which a user can confirm that a contact is to be deleted from a tribe.

FIG. 22 is an example of a graphical display of the contact being removed from the tribe.

FIG. 23 is an example of a telephone control panel.

FIG. 24 is an example of a user interface through which a user can indicate a desire to purchase additional pictures for use with personalization of the user's cellular telephone.

FIG. 25 is an example of a user interface through which a user can select among a catalog of available pictures.

FIG. 26 is an example of a user interface which can be presented once a user has purchased a selected picture.

FIG. 27 is an example of a user interface through which a purchased picture can be shared with a tribe.

FIG. 28 is an example of a user interface through which a user can select one or more tribes with whom a picture is to be shared.

FIG. 29 is a block diagram illustrating an example of a process flow for synchronizing an attitude according to an embodiment.

FIGS. 30 (a)-(d) show examples of interfaces through which a user can create a new tribe.

FIGS. 31 (a)-(c) show examples of interfaces through which a user can invite a contact to join a tribe.

FIGS. 32 (a)-(d) show examples of interfaces through which a user can change the mood that appears for all the contacts in a tribe.

FIGS. 33 (a)-(b) show examples of interfaces through which a user can change the mood that appears on another phone by calling that other phone.

FIGS. 34 (a)-(c) show examples of interfaces through which a user can broadcast an SMS to all the contacts in a tribe.

FIGS. 35 (a)-(c) show examples of interfaces through which a user can add new content for use with personalization of the user's cellular telephone.

FIGS. 36 (a)-(c) show examples of interfaces through which a user can see that the content of the handset's locker matches the content of the locker on the web.

FIGS. 37 (a)-(b) show examples of interfaces through which a user can see the new content that is available for use with personalization of the user's cellular telephone.

FIGS. 38 (a)-(c) show examples of interfaces through which a user can add user generated content for use with personalization of the user's cellular telephone.

FIG. 39 shows an example of a mobile interface and a web interface through which a user can choose the image and ringtone that appears on a friend's phone that the user is calling, wherein the user may also give the user's friends control of what image and ringtone will appear on the user's phone when the user's friends call the user.

FIG. 40 shows examples of interfaces through which a user can choose the image that user wants user's friends to see when user calls them.

FIG. 41 shows examples of interfaces through which a user can choose the ringtone that user wants user's friends to hear when user calls them.

FIG. 42 shows examples of interfaces through which a user can populate user's friends list from contacts in the phonebook of the user's handset.

FIG. 43 shows examples of interfaces through which the user's friends on the user's friends list can update their image and/or tone from the mobile application or the internet, wherein the application will be notified to update the friends' contact information.

FIG. 44 shows an example of an interface through which users can access their image and/or tone online, connecting the web and handset together seamlessly.

FIGS. 45 (a) and (b) show examples of interfaces through which a user can change their image and ringtone online, respectively.

FIGS. 46 (a) and (b) show examples of interfaces through which a user can upload an image from the user's PC and create a ringtone from one of the user's music files via the ringtone maker.

FIGS. 47 (a)-(d) show examples of interfaces through which a user can take a picture from the user's phone and use it as their image and record a sound file to use as their tone.

FIGS. 48 (a) and (b) show examples of interfaces through which a user can see user's friends list image and ringtone in the mobile application and web site, respectively, wherein the user may also customize the image and ringtone user's friend will hear when user calls them.

FIGS. 49 (a) and (b) show examples of interfaces through which a user can invite user's friend to use the system if the friend is not a member, wherein all of user's friends can customize and personalize the ringtone and image on the user's phone for the user.

### DETAILED DESCRIPTION

Various embodiments of the present invention may include web-enabled devices such as, but not limited to, web-browsers, computers, personal digital assistant, and/or a server-based application programming interface (“API”). Reference will now be made in detail to embodiments of a telephone personalization system, examples of which are illustrated in the accompanying drawings.

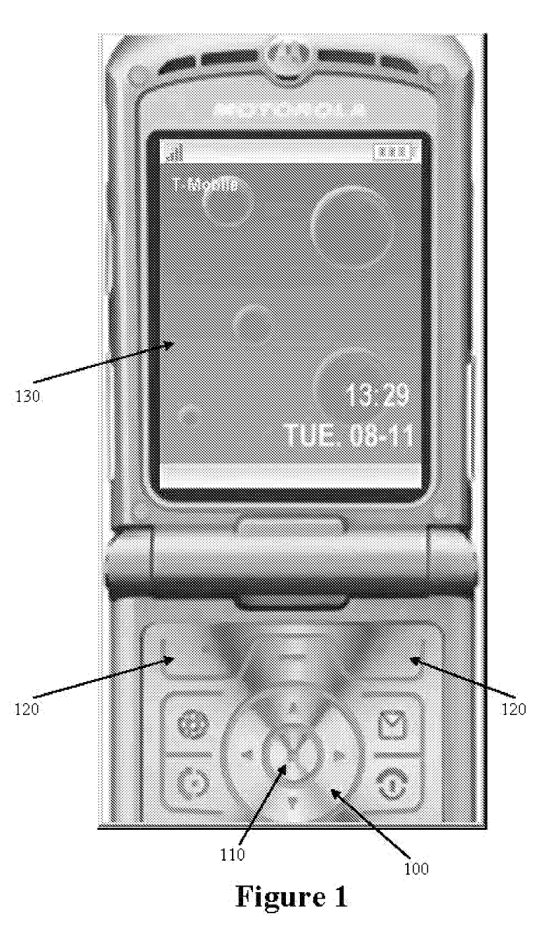

FIG. 1 is a simulated traditional cellular telephone. Such a cellular telephone can comprise a navigation means such as navigation button 100, an “enter” button 110, menu selection buttons 120, and a screen 130. Screen 130 can display information to a user, and buttons 100, 110, and 120 can permit the user to interact with the cellular telephone, including facilitating interactions based on information displayed on screen 130.

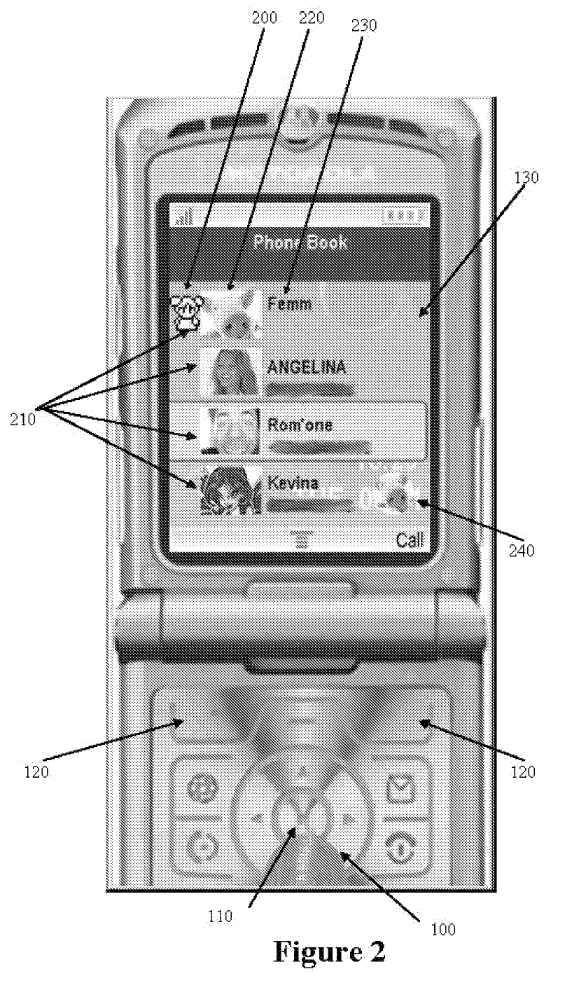

FIG. 2 is an example of a contact list on a cellular telephone on which embodiments of the disclosed telephone personalization system and methods has been implemented. In the embodiment illustrated in FIG. 2, as with traditional contact lists, each contact list entry 210 can be associated therewith a photograph 220. A name 230 and additional information, including, without limitation, one or more E-mail addresses, Internet Protocol (“IP”) addresses, and/or telephone numbers, can also be associated with each such contact list entry 210.

A contact list entry 210 may have one or more tribe icons 200, and one or more tribe membership pictures 240 associated therewith. Tribe icon 200 can be displayed alongside a contact list entry when that entry corresponds to a tribe, thereby providing an easily identifiable means for distinguishing between tribe contact list entries and contact list entries corresponding to a person. The term person, as used herein in the context of contact list entries, is intended to encompass both individuals and other types of entities, including businesses, governmental agencies, service providers, or the like. Tribe membership picture 240 provides a visual means for readily identifying whether a person corresponding to a contact list entry is a member of one or more tribes and, if so, the tribe(s) of which they are a member.

A tribe is a collection of one or more persons, and represents a social network of people through which the members can interact. As will be discussed in more detail below, a user can create a tribe at will, and can define the members of the tribe. In some embodiments, tribes are user-specific; that is, a tribe member may not have any knowledge of their membership in that particular tribe, or the existence or identity of other tribe members. In some embodiments, other users may have knowledge of the other tribe members and/or the existence of the tribe, but may not be permitted to modify a tribe's membership. Some embodiments allow all tribe members to control the tribe's membership, including modifying information associated with another tribe member, voting to remove a member of the tribe, and the like. In some such embodiments, these levels of awareness and control can be modified by the user creating the tribe, thereby providing additional flexibility.

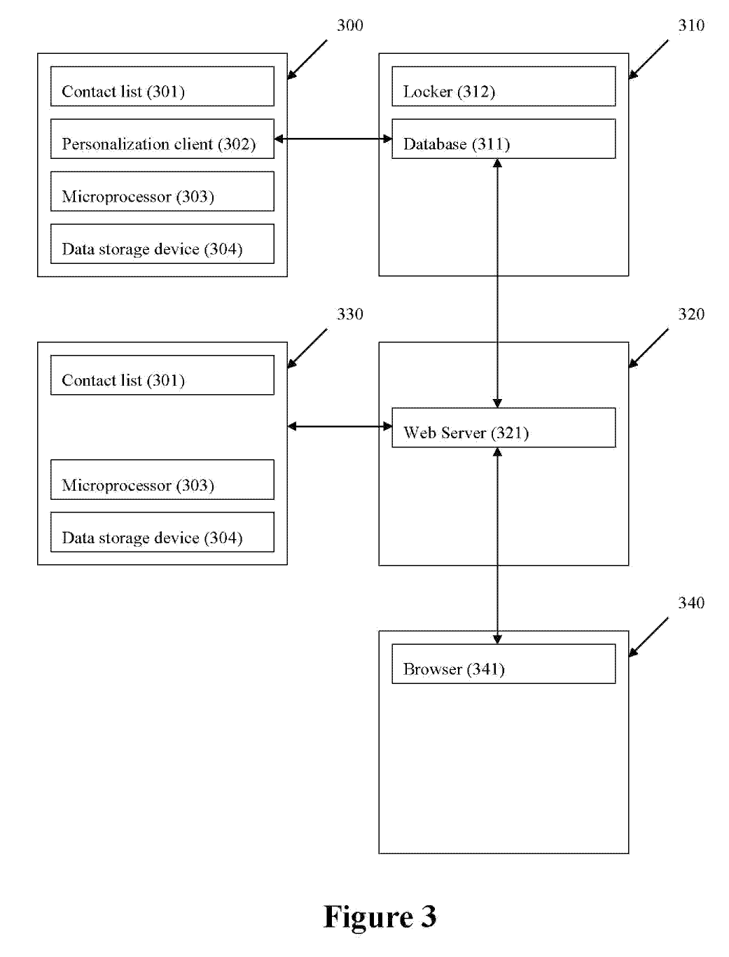

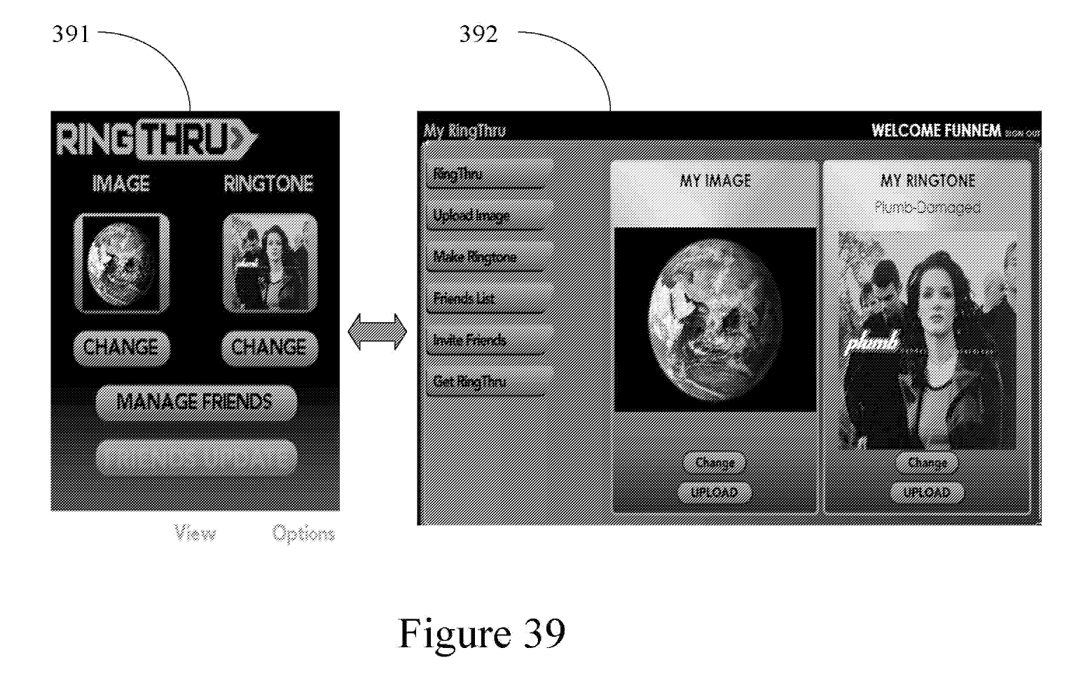

FIG. 3 illustrates an example of a system architecture for providing a telephone personalization system and methods according to some embodiments. The telephone personalization system and methods described herein are implemented in software that can be run by a microprocessor or other such device on the cellular telephone 300, hereinafter referred to as a personalization client 302 or personalization website 392, as shown if FIG. 39. As a component of cellular telephone 300, personalization client 302 may comprise a software module executed by cellular telephone 300. Personalization client 302 may be pre-installed or installed on the telephone at the time the telephone is purchased by the user, or the user may install personalization client 302 after the telephone is purchased. In some embodiments, personalization client 302 may be implemented as one or more software modules written in a portable language, such as, but not limited to, JAVA, J2ME, Binary Runtime Environment for Wireless (“BREW”), C++, Objective C, Symbian, or the like, thereby facilitating software compatibility across various telephone models.

In some embodiments, as illustrated by FIG. 3, cellular telephone 300 may comprise a contact list 301, personalization client 302, one or more microprocessors 303, and one or more data storage devices 304. Personalization client 302, executing on microprocessor 303, can access contact list 301 and data stored in data storage device 304. In some embodiments, contact list 301 can comprise the contact list elements and functionality described above. For example, personalization client 302 can modify a contact list entry 210 of FIG. 2. In some embodiments, data storage device 304 may comprise memory internal to cellular telephone 300, such as, but not limited to, NAND Flash, NOR Flash, or the like. In some embodiments, data storage device may further comprise a removable memory device, such as, but not limited to, TransFlash, SecureDigital (“SD”), xD, miniSD, MMC Mobile, or the like.

In some embodiments, a system architecture for providing the telephone personalization system and methods described herein may comprise at least one cellular telephone 300 and client server 310, client server 310 further comprising a database 311. Database 311 comprises a plurality of electronic records, the electronic records representing each tribe's organization and preferences. In some embodiments, the electronic records may further comprise other data associated with a tribe, such as, but not limited to, ring tones, tribe membership picture 240, tribe icon 200, or the like. In some embodiments, each user of the system may be identified within the system by their cellular telephone number. In some embodiments, each user may be identified by a Universally Unique Identifier (“UUID”).

Suitable software for providing database 311 includes, but is not limited to, Microsoft Access or Microsoft SQL Server distributed by Microsoft Corporation of Redmond, Wash., Oracle Database distributed by Oracle Corporation of Redwood Shores, Calif., MySQL distributed by Sun Microsystems, or the like. In some embodiments, database 311 is communicatively coupled to cellular telephone 300, thereby allowing database 311 and personalization client 302 to exchange data via one or more messaging protocols, such as, but not limited to, the Short Message Service (“SMS”), the Multimedia Messaging Service (“MMS”), the Enhanced Message Service (“EMS”), the Short Message Peer-to-peer Protocol (“SMPP”), HyperText Transfer Protocol (“HTTP”) message, SSL (“Secure Socket Layer”), HTTPS (“Hypertext Transfer Protocol Secure”), TCP/IP (“Transmission Control Protocol/Internet Protocol”), or the like. The data may be encrypted via one or more encryption algorithms such as, but not limited to, the Advanced Encryption Standard (“AES”), Triple Data Encryption Standard (“3DES”), or the like.

In some embodiments, personalization client 302 must be running prior to it being able to interact with client server 310 and provide the functionality of the instant disclosure. In some embodiments, cellular telephone 300 may start personalization client 302 upon receipt of a message from client server 310. The message may be received through appropriate communications including, but not limited to, SMS, IM, or BREW. In some embodiments, when executed, personalization client 302 may ask the user whether to initiate communication with client server 310.

In some embodiments the system architecture may further comprise a customer server 320, customer server 320 further comprising a web server 321. Suitable software for providing web server 321 includes, but is not limited to, Internet Information Server (“IIS”) distributed by Microsoft Corporation of Redmond, Wash., Apache HTTP Server distributed by The Apache Software Corporation of Forest Hill, Md., or the like. Customer server 320 is communicatively coupled with client server 310, thereby allowing web server 321 to interact with database 311. In some embodiments, web server 321 provides a web interface such that a user can create, modify, and manage their tribes via a web browser on a computing device, such as a PC, with internet connectivity. Such functionality can be beneficial in certain situations, such as when the user wants to make significant changes to existing tribes or input a significant number of new contacts. In some embodiments, web server 321 can allow a client-less cellular telephone 330 (e.g., a cellular telephone that does not have personalization client 302 installed) to download and install personalization client 302 via one or more communication protocol, such as, but not limited to, HTTP, File Transfer Protocol (“FTP”), or the like.

As will be appreciated by one of ordinary skill in the art, the system architecture for providing the telephone personalization system and methods may be altered to account for performance, cost, reliability, or other such concerns without departing from the spirit and scope of the instant disclosure. The components may be combined or further delineated to scale the architecture to suit a particular application.

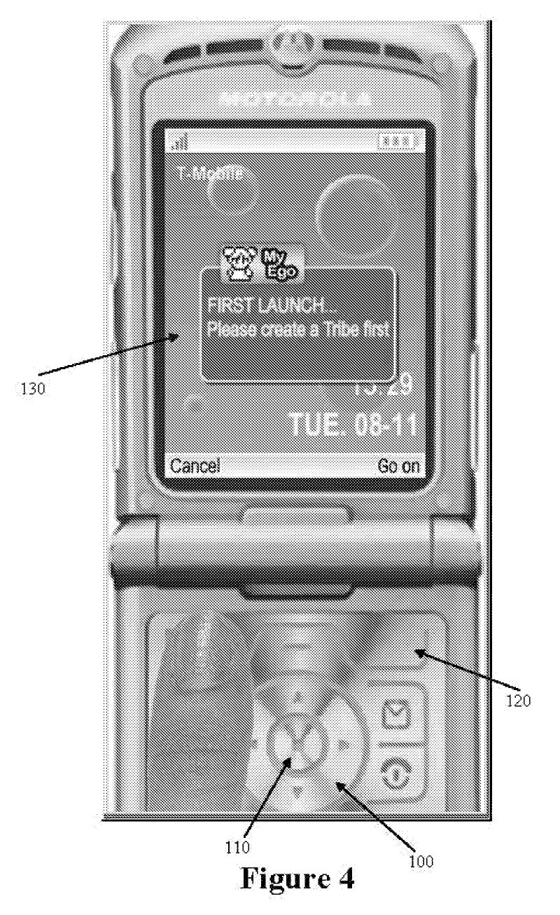

FIG. 4 shows an example of an introductory user interface presented to the user by personalization client 302 when the user first uses the telephone personalization system and methods. In some embodiments, many of the personalization features revolve around the concept of a tribe, and therefore the user may first be prompted to create a tribe, and by pressing one of selection buttons 120 the user can indicate their desire to create a tribe. In some embodiments, the tribe creation process walks the user through entering at least a minimum set of information necessary to define a tribe.

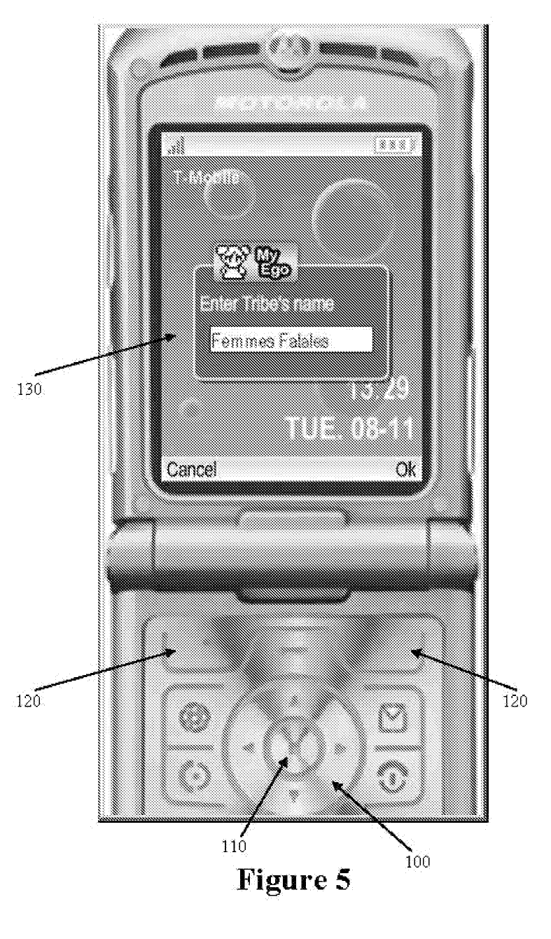

FIG. 5 is an example of a tribe information entry user interface. In this user interface, the user is prompted to enter a name for the tribe.

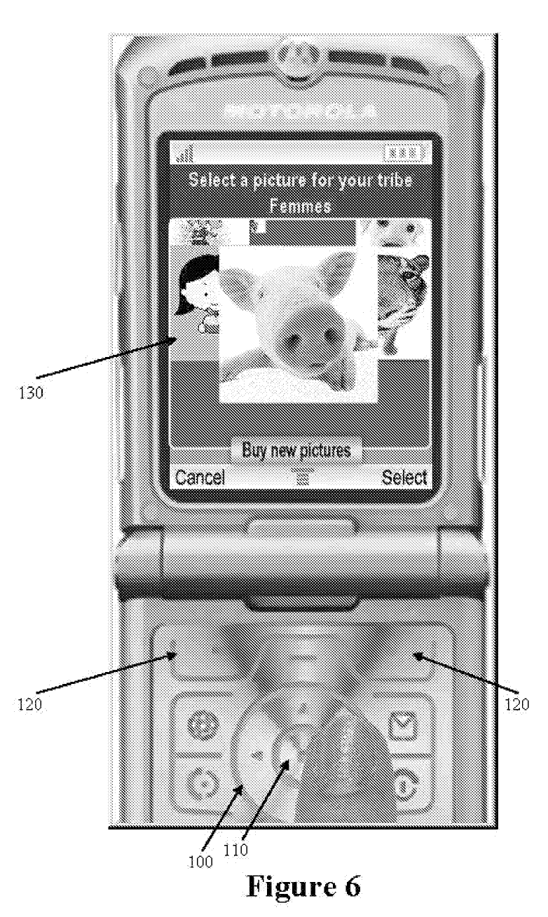

FIG. 6 shows a tribe photograph selection user interface in which the user may be prompted to select a picture to be associated with the tribe. In some embodiments, the user may be prompted to select a tribe photograph after the tribe's name has been entered. Such a picture may be selected from a set of pictures stored on the telephone, including without limitation, photographs taken by the user, photographs sent to the user by other users, pictures sent to the user by other users, pictures and/or photographs provided by third parties, and pictures purchased by the user from one or more service providers. Such pictures may be still or animated, including, without limitation, full motion video. Such pictures may be stored in one or more data storage device(s) 304 of cellular telephone 300. Pictures may also be obtained from devices external to the telephone, including devices in communication with the telephone via a wired or wireless Internet connection, a Bluetooth or other wireless connection, or a wired connection. A picture may also have one or more sounds associated therewith, or a sound may be substituted for a picture.

In some embodiments, after a tribe is created, personalization client 302 connects to client server 310 and stores data representing the tribe in database 311. Any further data associated with the tribe, such as, but not limited to, tribe icon 200, tribe membership pictures 240, or the like, may also be stored in database 311.

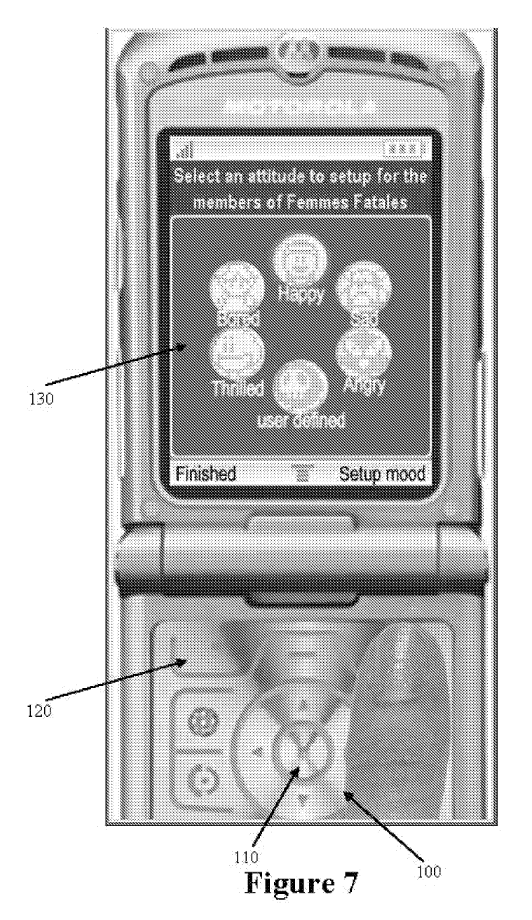

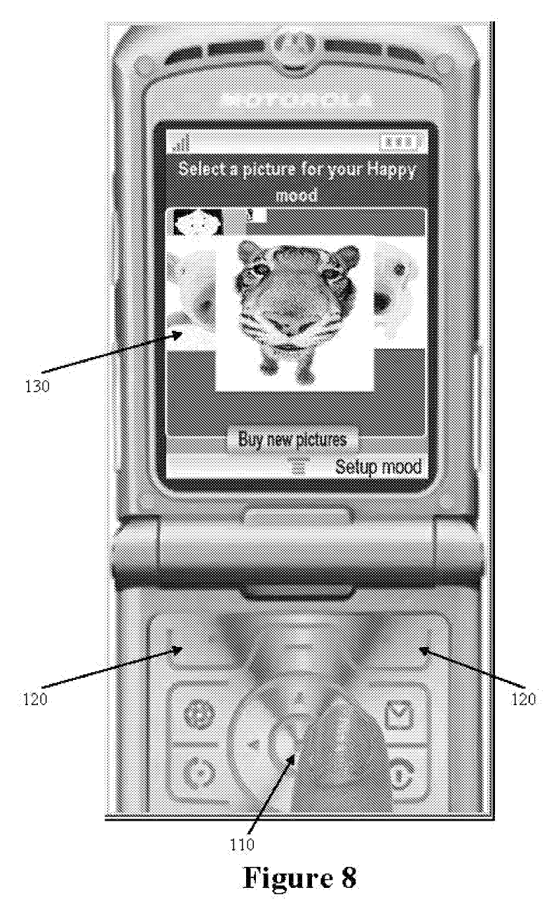

One motivation users may have for using the telephone personalization system and methods described herein is that they can project an attitude or emotion to other tribe members or users. FIG. 7 is an example of a tribe-specific attitude configuration user interface. In such a user interface, the user is able to select from a series of pre-defined attitudes, or to create a new attitude. The user can then define a series of tribe-specific preferences to be associated with the attitude, which can be accomplished via a user interface similar to that of FIG. 8. When the user elects to project an attitude to a tribe, personalization client 302 notifies client server 310 of the attitude and any preference information, or changes thereto, if needed. Personalization client 302 may also transfer any pictures associated with the attitude, to client server 310 of FIG. 3.

Client server 310 notifies all members of the tribe of the attitude and transfers any pictures associated with the attitude to their cellular telephones, wherein personalization client 302 running on the tribe member's cellular telephones allows them to see the picture associated with the user-selected attitude whenever the user's information is presented. By way of example, without limitation, tribe members may see the picture as an icon next to the user's information in an address book (e.g., similar to the way icon 200 is presented in FIG. 2), or the user-selected picture may be substituted for a picture associated with the user in the other members' contacts list. Similarly, when the user calls another tribe member, the user-selected picture may be displayed on the other tribe member's telephone as the telephone rings, in conjunction with or in lieu of caller ID or other such information. Certain embodiments may include an API that enables the user to connect to the client server 310 that calls the tribe member's telephones.

In some embodiments, the attitude may further comprise instructions to actuate the vibrate functionality of tribe member's cellular telephones in relation to the attitude. By way of example, without limitation, if the attitude is “anger”, the tribe member's cellular telephones may vibrate in multiple high intensity bursts, whereas if the attitude is “sad”, the vibration may be a single long burst of low intensity vibration.

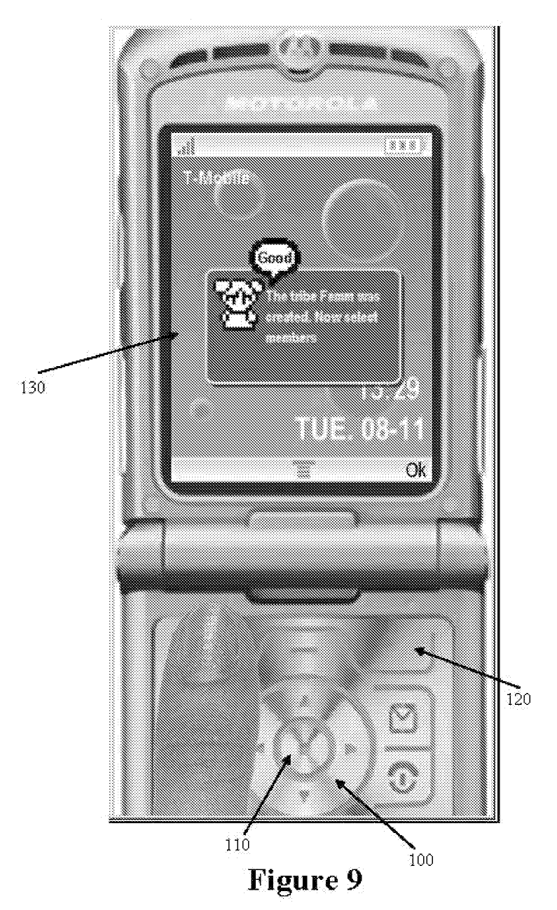

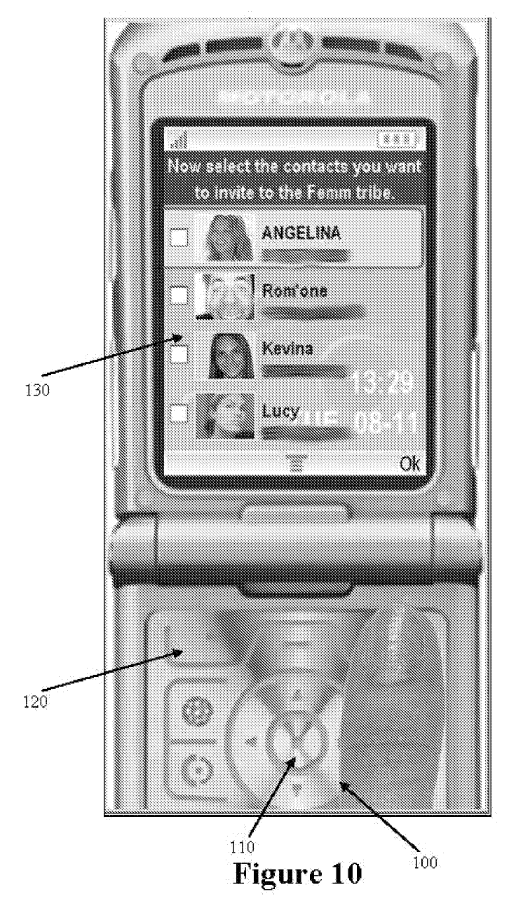

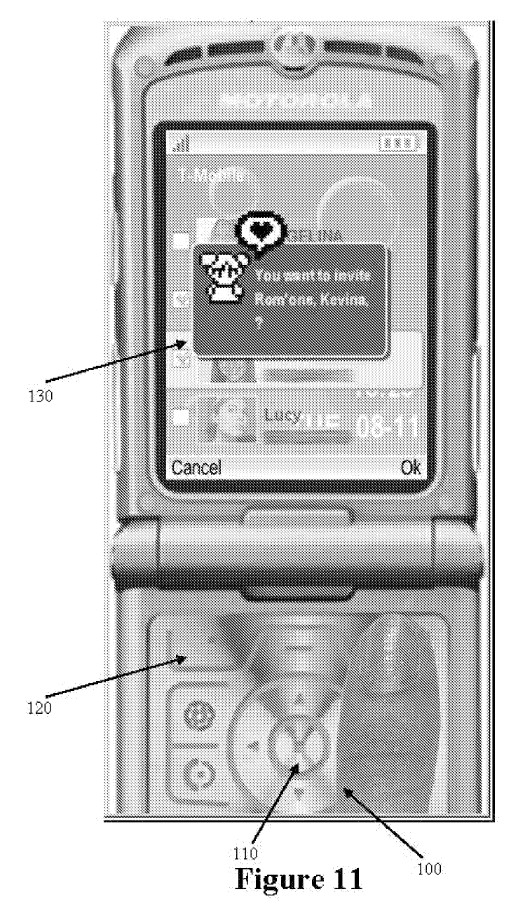

Once the tribe has been defined and basic tribe attributes have been entered, personalization client 302 may present the user with a tribe creation confirmation user interface similar to that of FIG. 9. The user may then be prompted to select the tribe's members. FIG. 10 is an example of a tribe member selection user interface. Once the tribe's members have been selected, the user is given an option to invite the members to participate in the tribe, such as through the user interface illustrated in FIG. 11. In some embodiments, invitations are processed by client server 310 and transmitted to each selected user that has personalization client 302 installed.

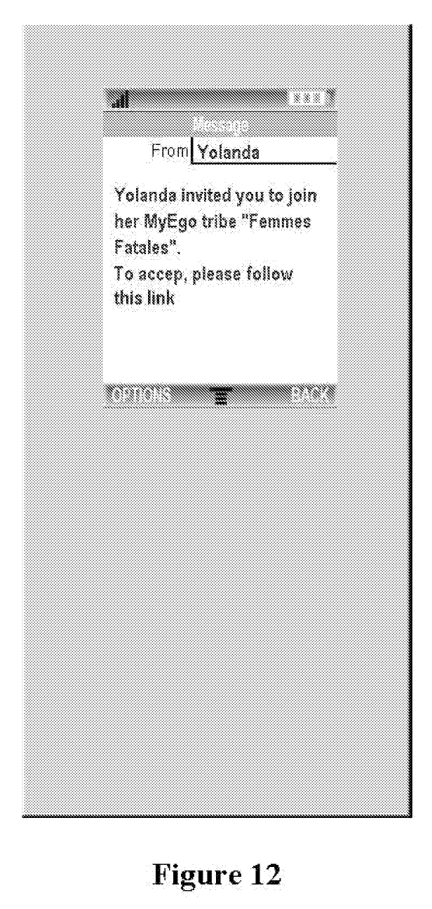

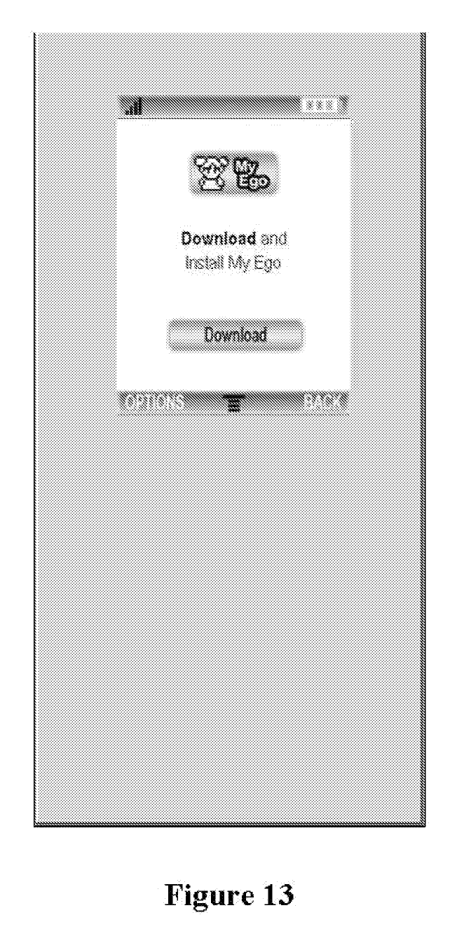

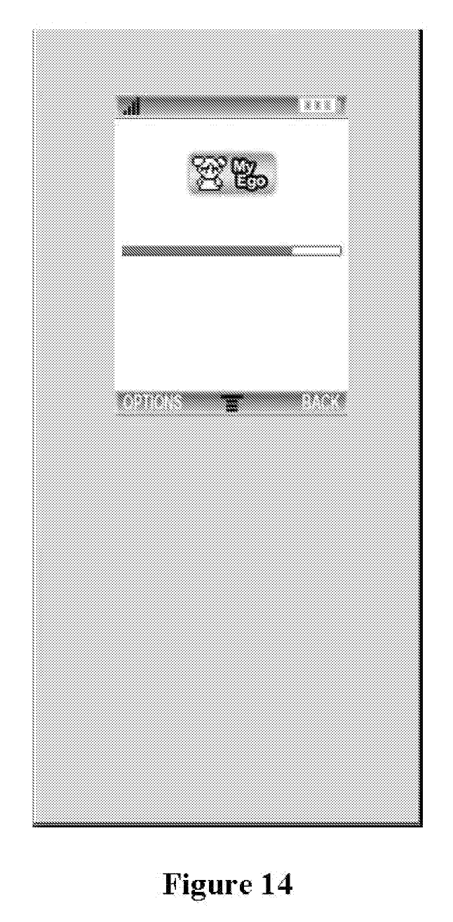

Referring again to FIG. 3, where an invitation recipient does not have personalization client 302 installed on their cellular telephone 330, the recipient may be presented with a series of user interfaces through which personalization client 302 can be obtained and installed, as illustrated in the example of a user interfaces of FIGS. 12-14. In FIG. 12, the recipient receives an SMS, E-mail, or other message from the user, and the message indicates that the user has invited the recipient to participate in a tribe. The message may also include information describing the social networking and personalization features available through personalization client 302, thereby enticing the recipient to participate. The invitation may further contain a Uniform Resource Locator (“URL”) or other interpretable instruction which facilitates the telephone acquiring personalization client 302. Such an interpretable instruction may be displayed for the recipient, or may be hidden within the invitation. With the recipient's approval, an appropriate download process is initiated, such as, without limitation, by having a browser associated with the telephone navigate to a URL (See FIG. 13). In some embodiments, web server 321 can provide personalization client 302 for download. In some embodiments, once personalization client 302 has been downloaded the recipient can authorize the installation of personalization client 302 on the recipient's cellular telephone, and the recipient can monitor the installation status through a user interface similar to that of FIG. 14.

In some embodiments, the user can elect to not send such an invitation, the tribe is a locally-defined tribe, and may only be known to and controlled by the user. In such embodiments, by sending an invitation to one or more selected tribe members, the user can indicate that the other invited members are to have some level of knowledge about and/or control over the tribe, and the user can specify the level of such knowledge and/or control. In some embodiments, the system may seek permission of the user creating a tribe before performing certain actions initiated by tribe members.

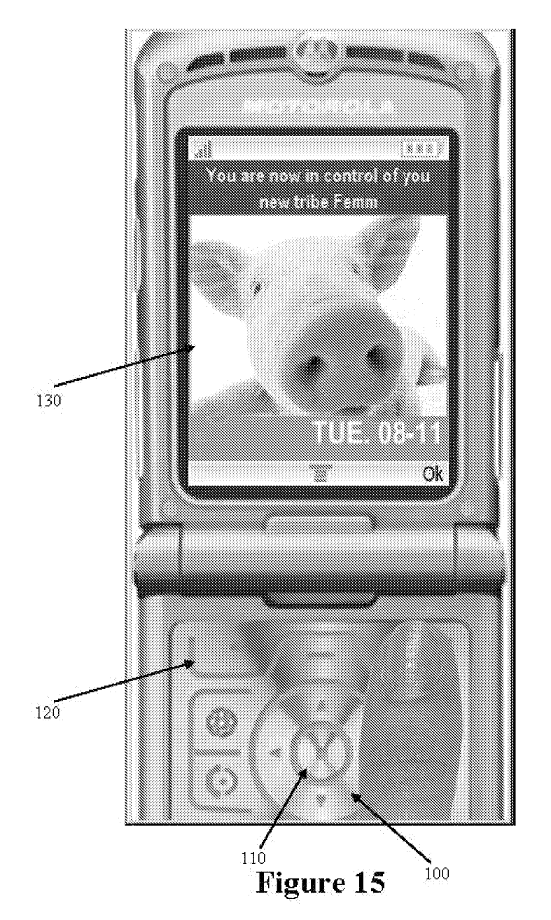

In some embodiments, once the tribe has been fully defined, including, without limitation, the definition of appropriate tribe attributes and the selection of at least one tribe member, personalization client 302 presents the user with a user interface similar to that of FIG. 15 which confirms that the user has created and is in control of the tribe.

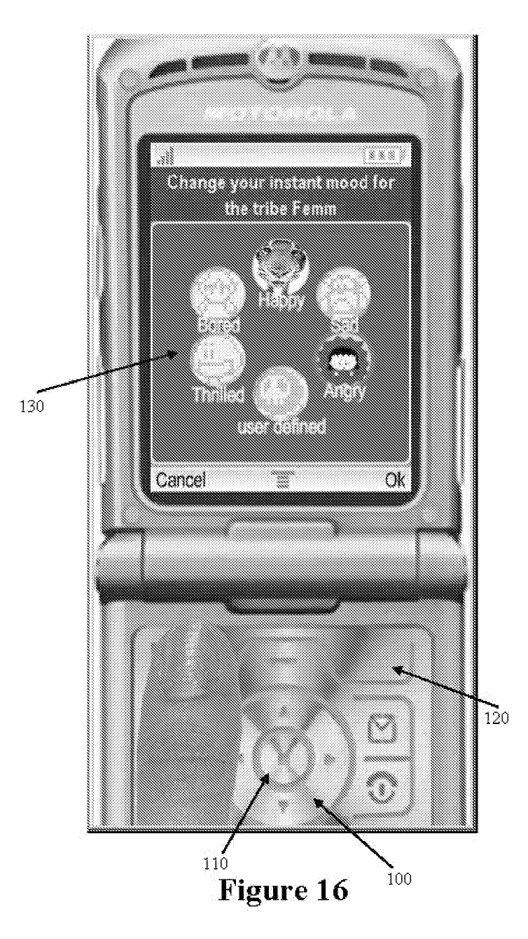

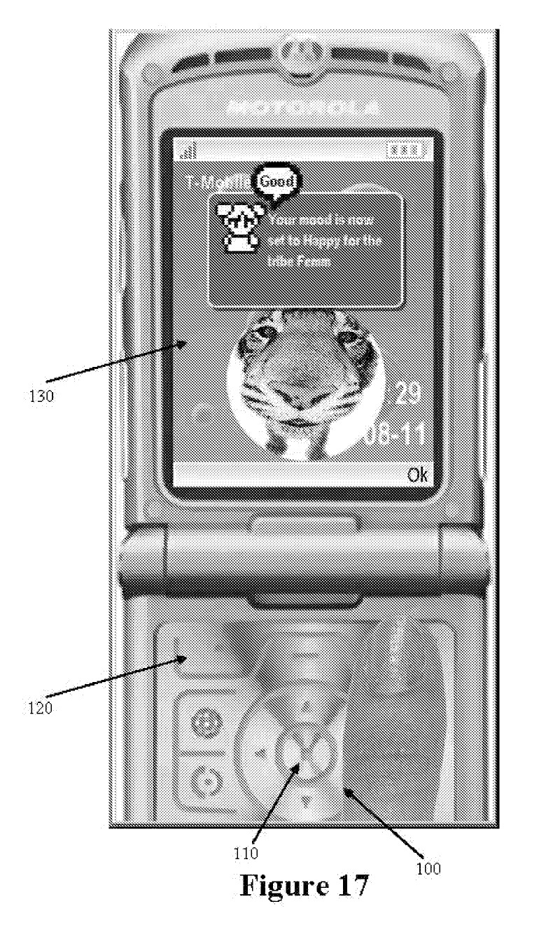

As described above, a feature of the telephone personalization system and methods is the ability to project an attitude to tribe members. Users may frequently wish to alter their projected mood, and FIG. 16 is an example of a tribe mood change user interface. In such an interface, the user simply selects the mood or attitude to be projected to the tribe members, and this new mood selection can be confirmed to the user by a user interface such as that of FIG. 17. When the user's mood changes, this information is relayed through client server 310 to the tribe members and/or their respective cellular telephones.

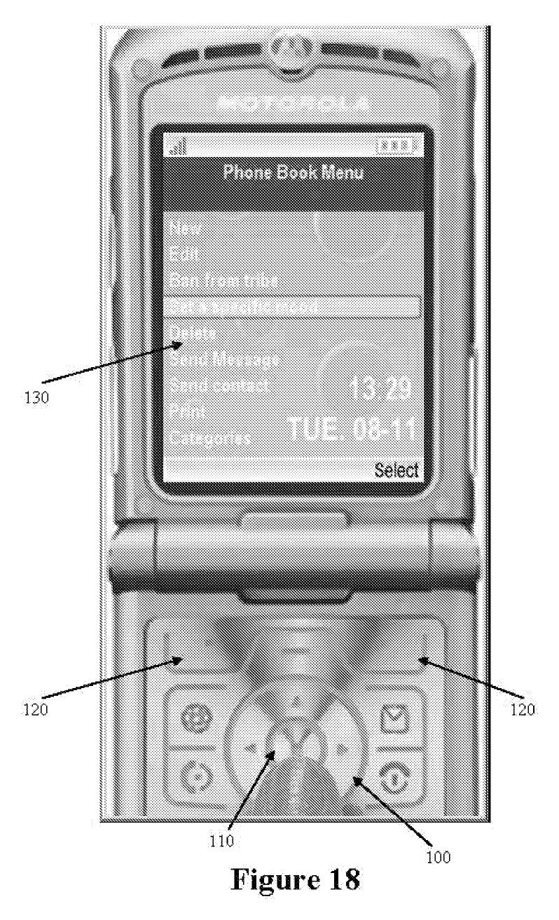

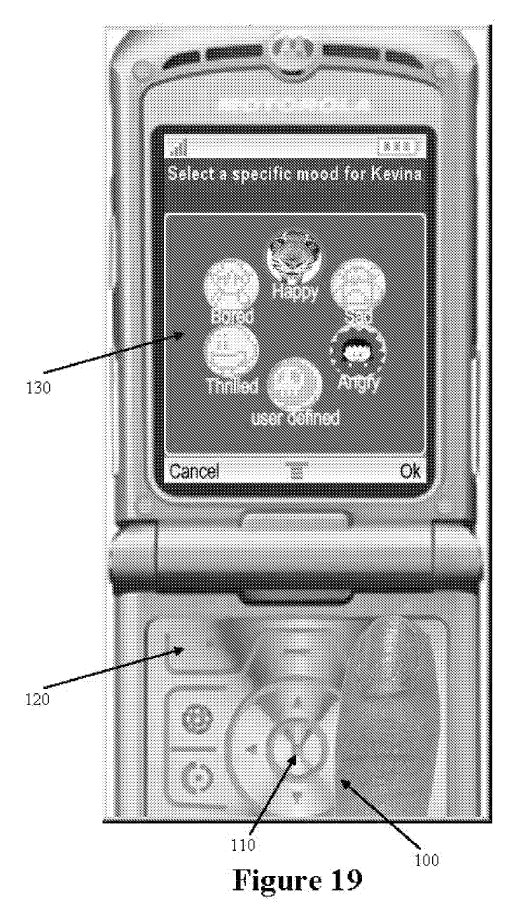

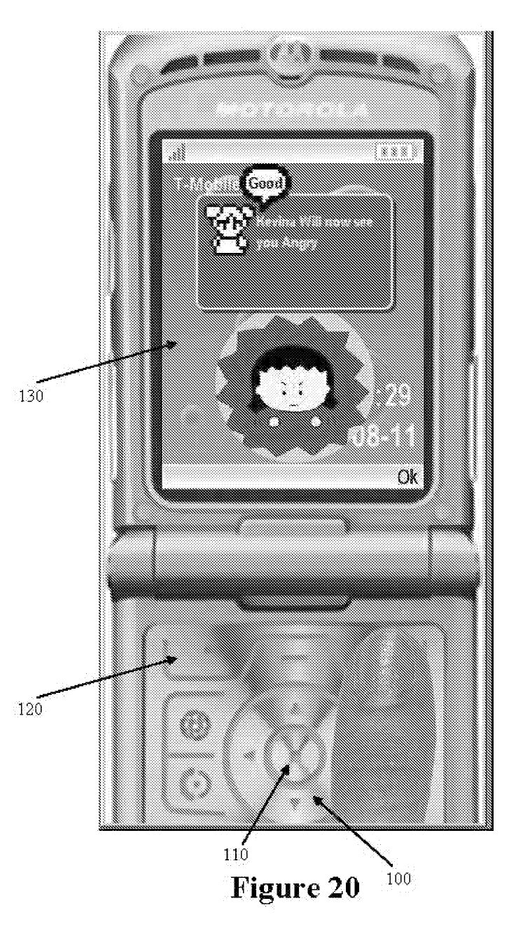

In some embodiments, personalization client 302 provides enhancements to the menus and other features typically installed on or associated with a telephone. By way of example, without limitation, where a telephone manufacturer or other such party makes available an application programmer interface (“API”), the telephone personalization system and methods can be implemented by personalization client 302 utilizing the functions available through the API. FIG. 18 is an example of an individual contact menu which has been modified through the use of such an API to include the “Ban from tribe” and “Set a specific mood” commands. By selecting the “Set a specific mood” command, the user can project a mood to a particular contact, and may do so through an individual contact mood selection user interface such as that of FIG. 19. In an embodiment, such a selection overrides any mood selections associated with any tribes to which the contact belongs. When the user has selected a desired mood, an individual contact mood selection confirmation user interface similar to that of FIG. 20 may be displayed.

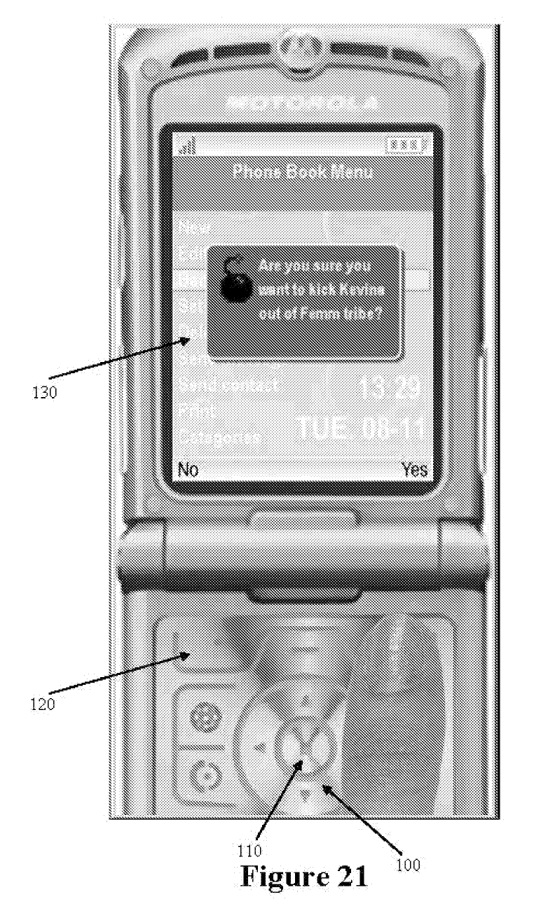

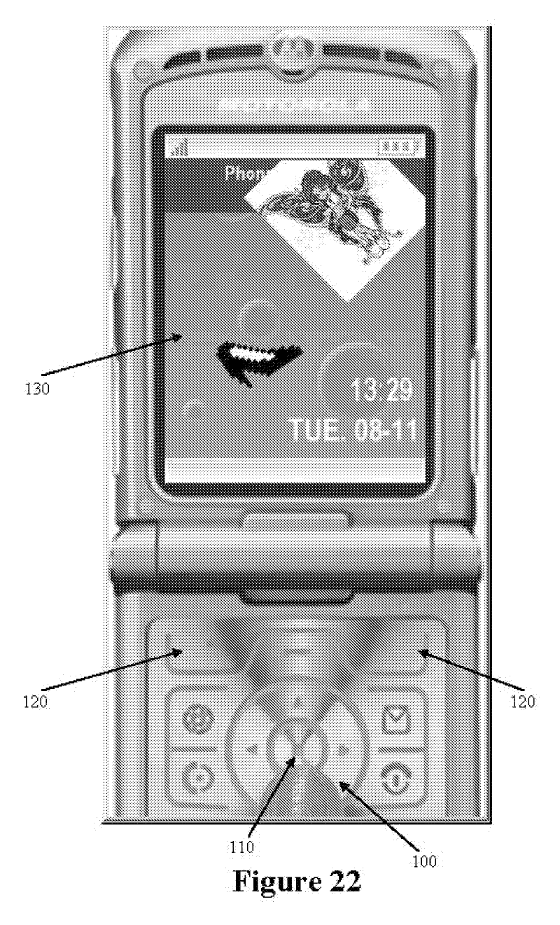

By selecting the “Ban from tribe” command from the individual contact menu of FIG. 18, the user can indicate that a contact is to be removed from a tribe. FIG. 21 is an example of a user interface through which a user can confirm that the contact is to be deleted from a tribe. In an embodiment, an animated picture, such as one based on the picture illustrated in FIG. 22, may be displayed to illustrate the removal of the contact from the tribe.

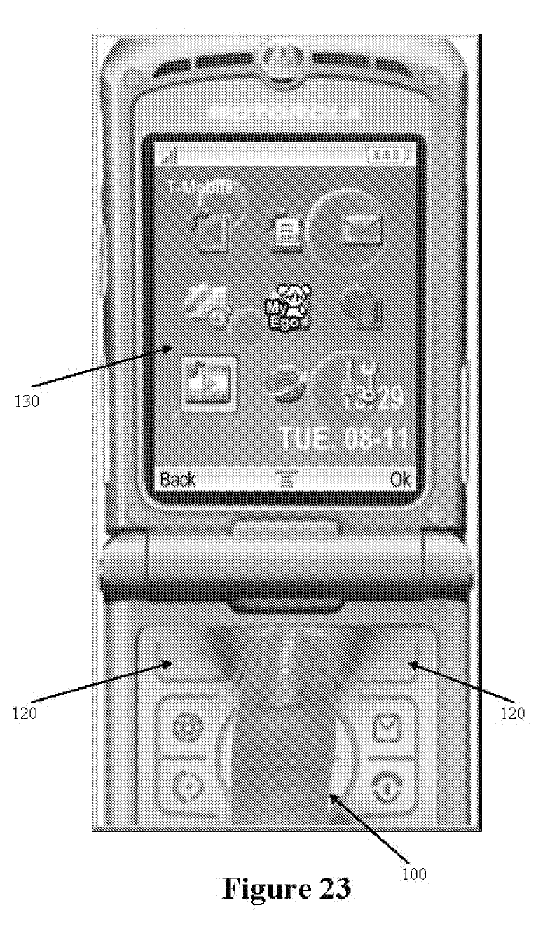

In addition to providing access to features of the telephone personalization system and methods by enhancing the menus and other user interface elements available on a telephone, personalization client 302 may also allow a user to access the personalization features through a more narrowly tailored user interface or series of user interfaces. By way of example, without limitation, personalization client 302 allows the personalization features to be accessed through a control panel applet similar to that illustrated in FIG. 23.

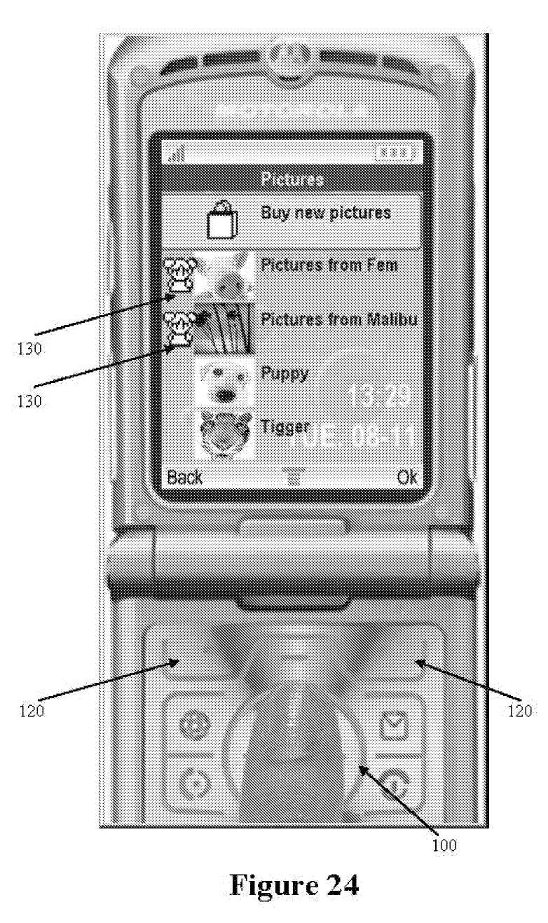

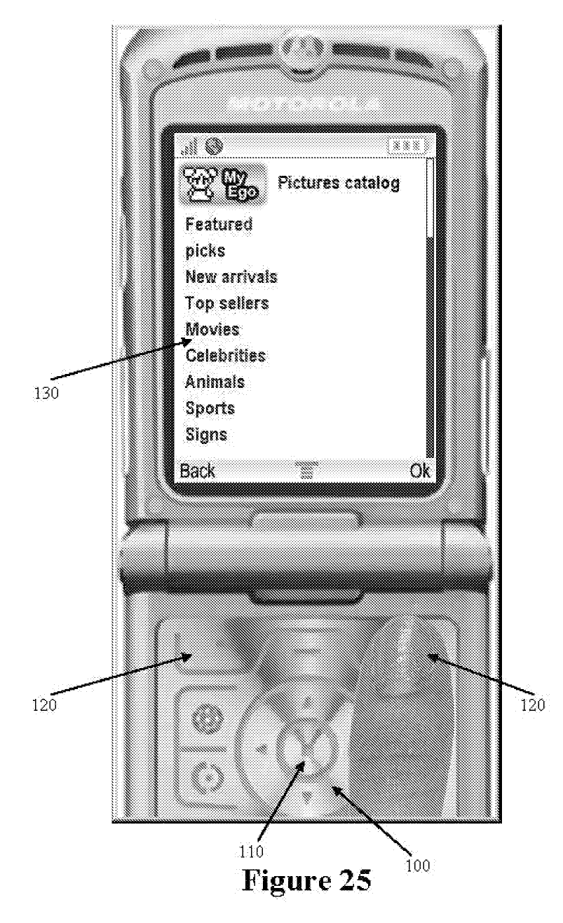

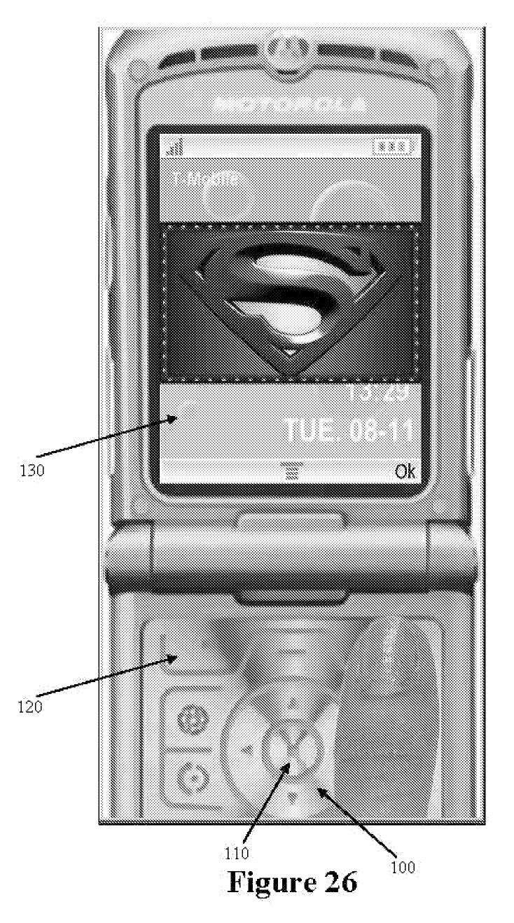

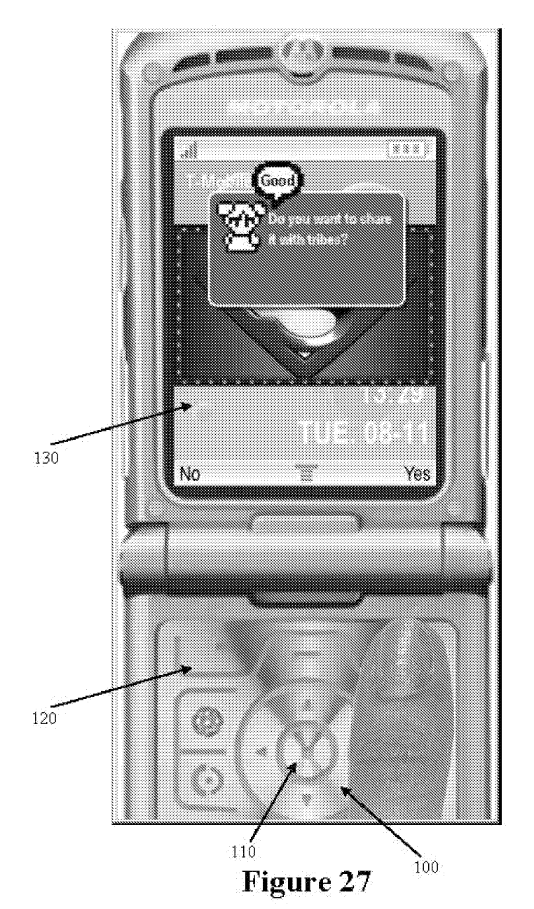

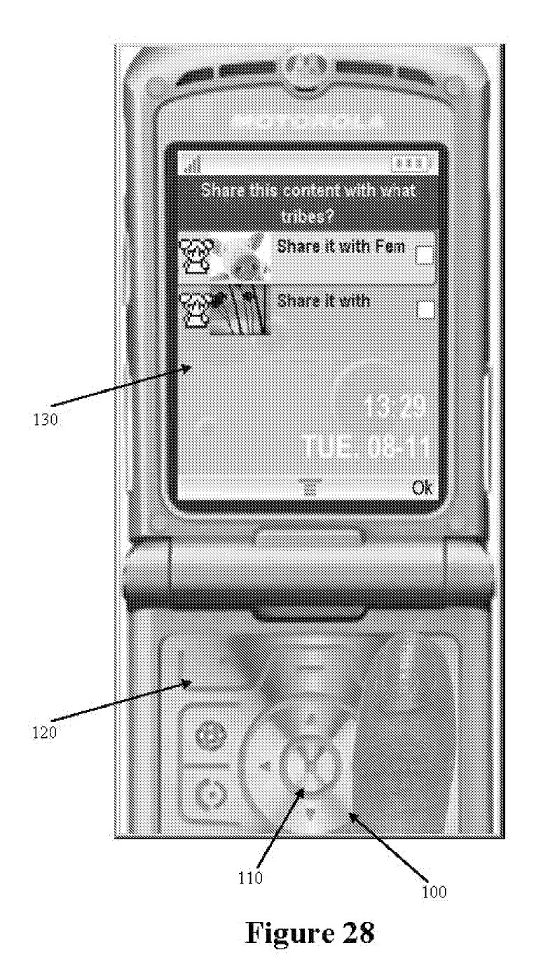

One such personalization feature that can be made available through the control panel applet is the ability to purchase additional pictures that can be used with a tribe. FIG. 24 illustrates an example of a user interface through which a user can indicate a desire to purchase such additional pictures. When the user selects the “Buy new pictures” menu item, the user is presented with a user interface similar to that of FIG. 25, through which the user can browse and select from among a catalog of available pictures. The user can select one or more pictures to be purchased or otherwise obtained from such a catalog, and can perform any E-commerce related activities through the telephone. In some embodiments, the cost of purchasing such pictures may be added to the user's telephone bill. Once the user has obtained a picture, the user may be presented with a user interface similar to that of FIG. 26, in which the obtained picture(s) are displayed. The user may then be asked whether the obtained picture(s) should be shared with one or more tribes, as illustrated by the user interface in FIG. 27. FIG. 28 is an example of a user interface through which a user can select the tribe(s) with which the picture(s) are to be shared. In an embodiment, sharing a picture with a tribe comprises permitting the tribe members to view the picture, but the tribe members may not have rights to use the picture for their own purposes.

In some embodiments, client server 310 may further comprise locker 312. Locker 312 provides a personal media repository for each user. In some embodiments, locker 312 may store the personal media as a plurality of electronic files within database 311. Personal media may include, but is not limited to, tribe icon 200, tribe membership picture 240, ring tones, pictures purchased through the telephone E-commerce functionality, content uploaded by the user, or the like. Although cellular telephone carriers typically facilitate the transfer of media between cellular telephones used on their own networks (e.g., when a user buys a new phone), many times they are unable or unwilling to transfer media, purchased applications, contact lists, and the like between cellular telephones provided by other cellular telephone carriers. As a result, the user must re-acquire the media, re-enter the contact information, and the like. Similarly, if the user's cellular telephone is lost or stolen, the user will have to re-acquire the media, re-enter the contact information, etc. Locker 312 allows the user to easily store and recover their media, contacts, applications, and the like.

In some embodiments, locker 312 allows the user to make their media available to other tribe members. The user may select which media to make available by grouping or on an individual file basis. After a subset of the user's media is made available to the tribe, the tribe members may be informed of its availability via a message or client server 310 may automatically push the media to each tribe member's cellular telephone 300. By way of example, without limitation, the user may purchase a holiday picture through the cellular telephone's E-commerce functionality, and make it available to other tribe members. By way of another non-limiting example, the user may create an audio clip of an event and make it available to other tribe members.

In some embodiments, locker 312 may read and enforce Digital Rights Management (“DRM”) data contained within the media. By way of example, without limitation, the user may purchase a ring tone, and only be allowed to transfer the ring to their current cellular telephone or a new cellular telephone, should they purchase one. In some embodiments, the user may be given the option to purchase media, with a license allowing the media to be distributed within the tribe or to other users of the instant system.

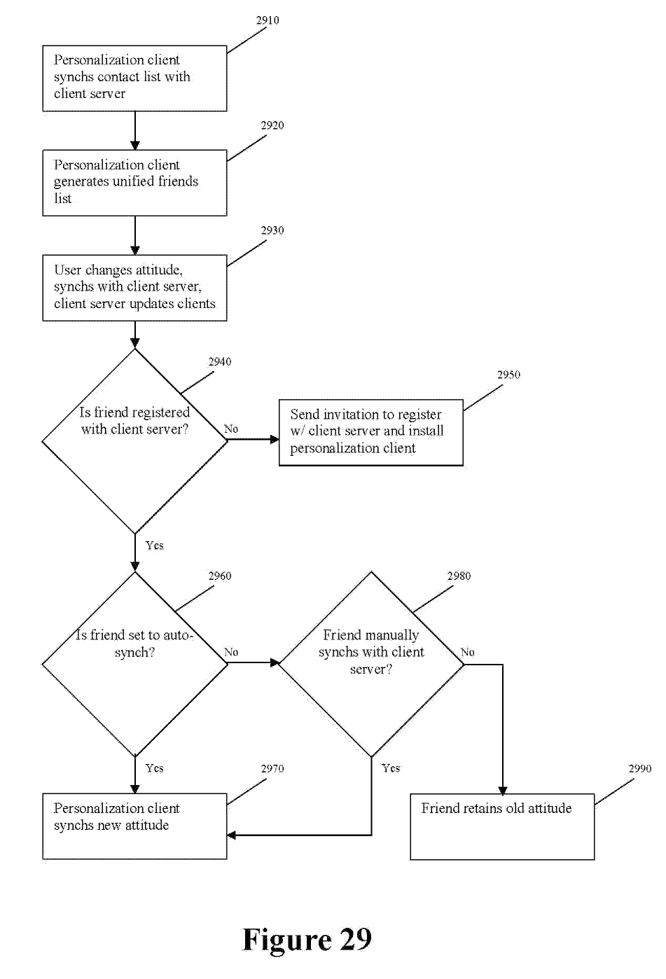

In some embodiments, as illustrated by FIG. 29, the process for projecting an attitude is initiated by personalization client 302 synchronizing contact list 301 with client server 310, as shown in block 2910. Each contact within contact list 301 may be cross-referenced against the registered users on client server 310. Such cross-referencing may be implemented using a variety of identification means, including, without limitation, the user's telephone number. Client server 310 returns those contacts within the contact list that are registered. In some embodiments, in block 2910, personalization client may ask the user to send invitations to members in contact list 301 who are not registered users.

In block 2920, personalization client 302 generates a unified friends list, the unified friends list comprising: friends who are in contact list 301, but not registered with client server 310; friends who are in contact list 301 and registered with client server 310; and, friends who not in contact list 301, but are registered with client server 310. The unified friends list allows the user to project an attitude to friends who are not in contact list 301, such as those with whom the user has configured an association via a web-based form provided by client server 310.

In block 2930, the user changes their attitude through personalization client 302 and/or web browser 392, which initiates a synch with client server 310. In some embodiments, personalization client 302 will automatically initiate the synch with client server 310, whereas in some other embodiments, the synch will not occur until approved by the user. Once the synch is initiated, personalization client 302 transmits the data associated with the attitude to client server 310, for transfer to those friends to whom the new attitude will be projected. By way of example, the user may project a new attitude for his or her birthday, the attitude containing a “happy birthday” ring tone. In this example, personalization client 302 would transmit the ring tone to client server 310 for transfer to the user's friends. After receiving the attitude, client server 310 processes each friend to be updated.

In block 2940, client server 310 determines whether the friend is a registered member, with personalization client 302 installed on their device. If the friend is not registered, client server 310 can send them a message containing a URL to download and install personalization client 302 through, as shown in block 2950. If the friend declines to register with client server 310, the new attitude will not be projected to the friend's cellular telephone. In some embodiments, if a friend is registered, client server 310 may detect whether personalization client 302 has been removed or disabled. In the event that personalization client 302 has been removed or disabled, client server 310 will send an invitation per block 2950.

In block 2960, client server 310 sends a synch request to personalization client 302 executing on the friend's cellular telephone. In some embodiments, if the cellular telephone is unavailable, the synch request will be processed when the cellular telephone becomes available again. If the user calls the friend prior to the synch being completed, the old attitude will be associated with the user. Referring to the previously described birthday ring tone example, the user's old ring tone would be used, instead of the new birthday ring tone.

If the friend is set to auto-synch, personalization client 302 executing on the friend's cellular telephone will automatically reply to the synch request and initiate a synch with client server 310, as shown in block 2970. After the synch is completed, the new attitude will be associated with the user, e.g., the birthday ring tone would be used. In some embodiments, personalization client 302 may allow the friend to select to always auto-synch, or allow the friend to select the users for whom auto-synch should be enabled.

Referring to block 2980, if personalization client 302, executing on the friend's cellular telephone, is not set to auto-synch, personalization client 302 may present the friend with a dialog asking whether to synch or not. If the friend chooses to synch, personalization client 302 will synch the new attitude as shown in block 2970. If the friend declines the request to synch, as shown in block 2990, the previous attitude associated with the user will be used in place of the new attitude.

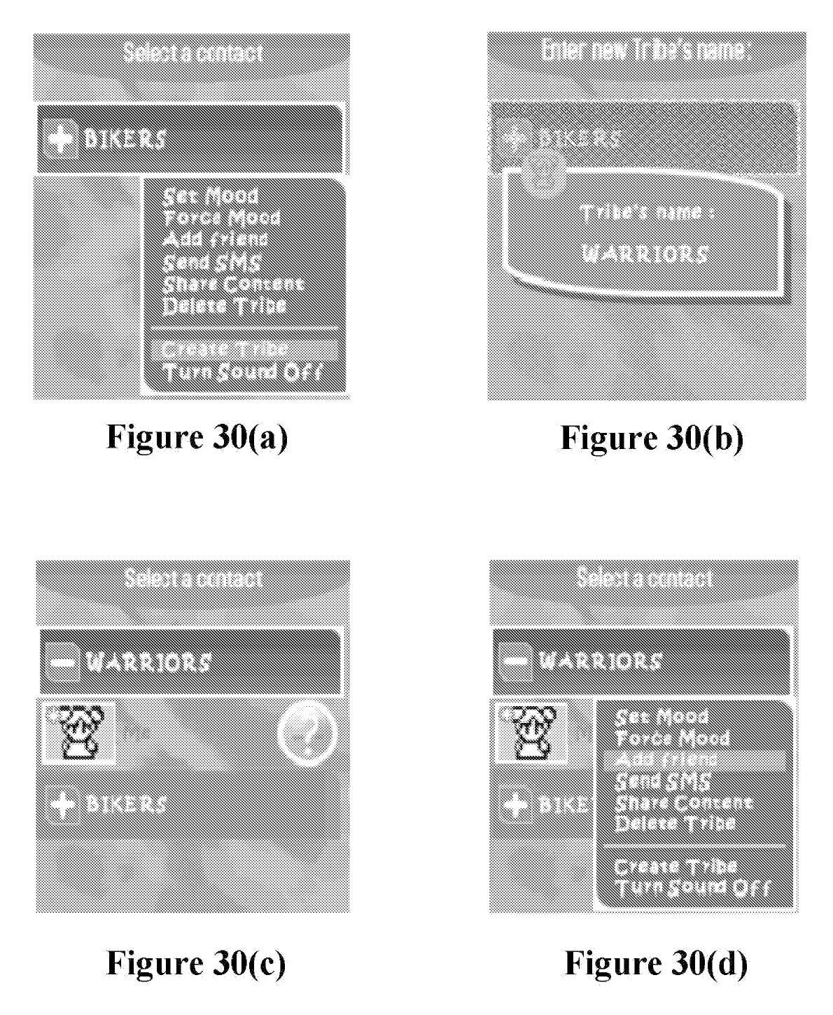

FIGS. 30 (a)-(d) illustrate another embodiment for the creation of a new tribe on a handset. After the tribe name is entered, the tribe appears as a highlighted item. See FIG. 30(c). Under this tribe, the item “ME” represents the user. The star indicates that the user is the owner of the tribe. The user may press the hotkey to call the menu, as shown in FIG. 30(d). The user may then select the “Add friend” feature.

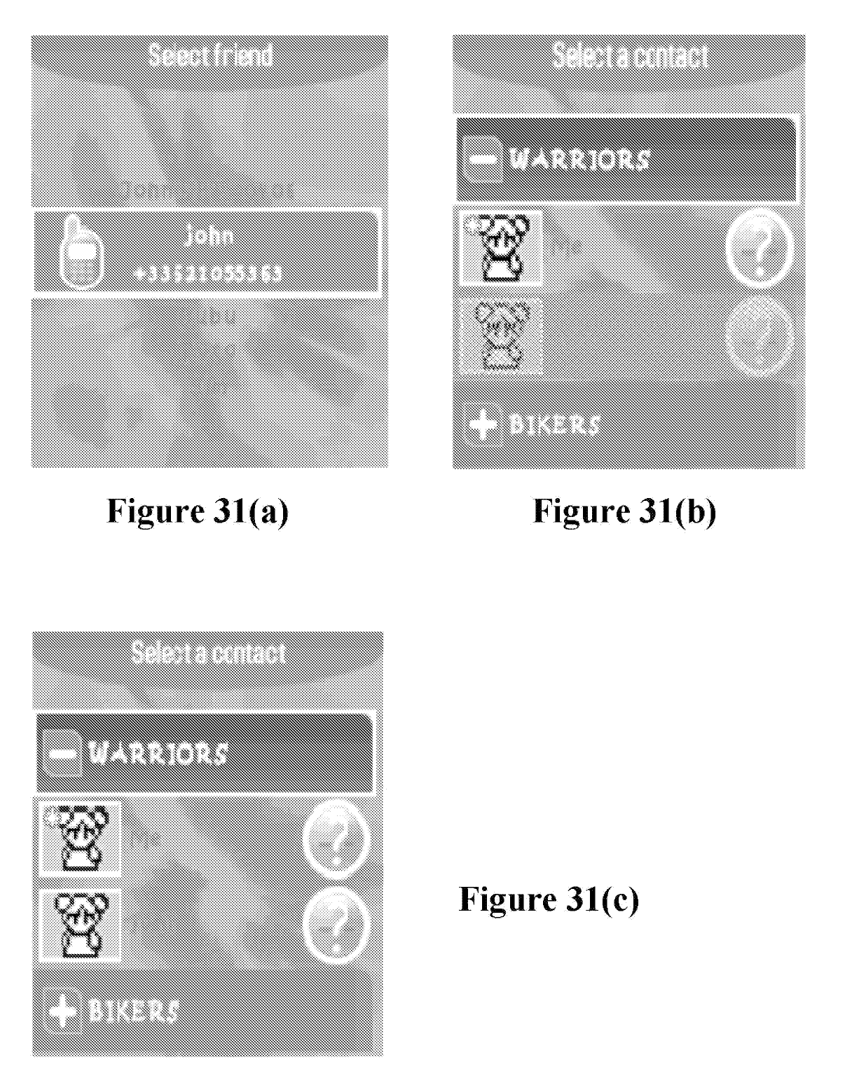

FIGS. 31 (a)-(c) show examples of interfaces through which a user can invite a contact to join a tribe. In some embodiments, the user may select the contact to be invited by calling the contact from the contact list. As illustrated in FIG. 31(b), the newly invited contact will appear as a grayed item below the tribe item. It may remain grayed until the contact accepts the invitation, as in FIG. 31(c).

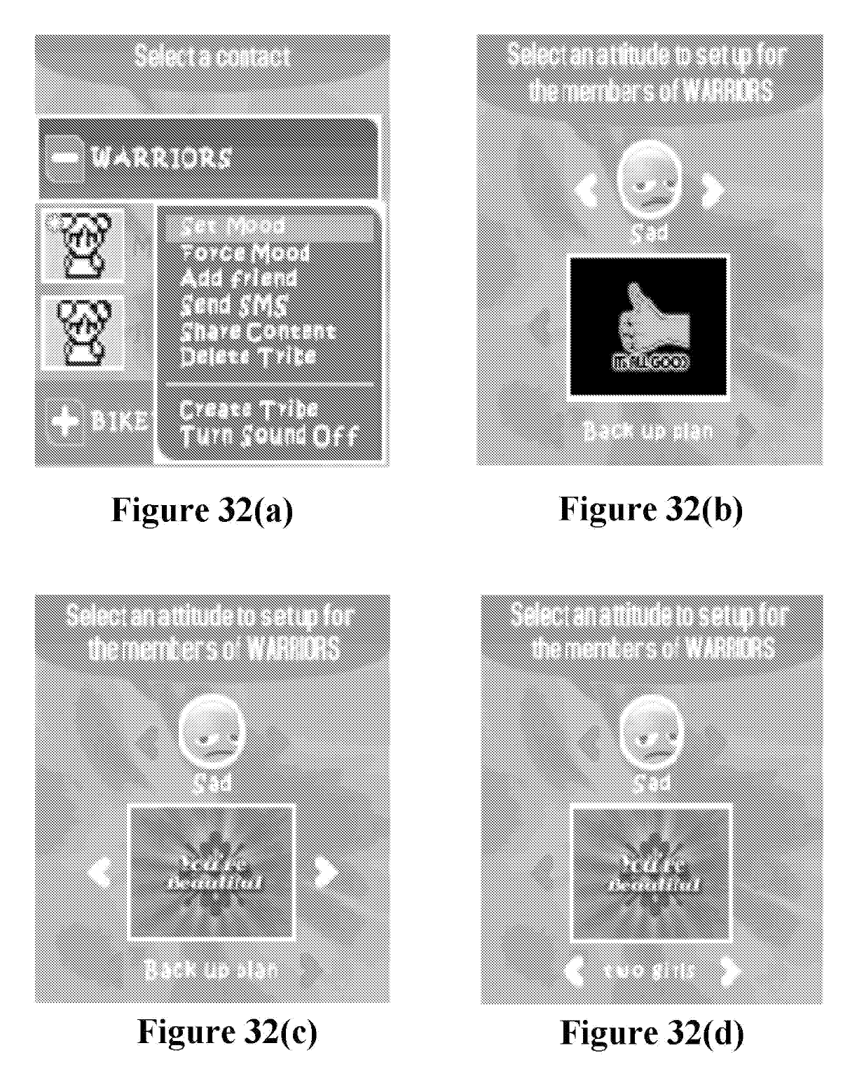

FIGS. 32 (a)-(d) show examples of interfaces through which a user can change the mood that appears for all the contacts in a tribe. The user may highlight a tribe or the ME item and invoke the menu, as depicted in FIG. 32(a). After the user selects the “Set Mood” feature, the user may move right or left to select a mood description. When done, the user may move down to select a picture by moving left or right to browse through the picture gallery. Those are the pictures from the user's locker that were assigned to the user's handset. If no pictures are displayed, the user may launch the user's locker. The user may then move down to select a ring tone. When satisfied with the selection, the user may press an “OK” key to confirm the selection. The new settings will be automatically sent during the next synchronization (approximately 30 to 60 seconds).

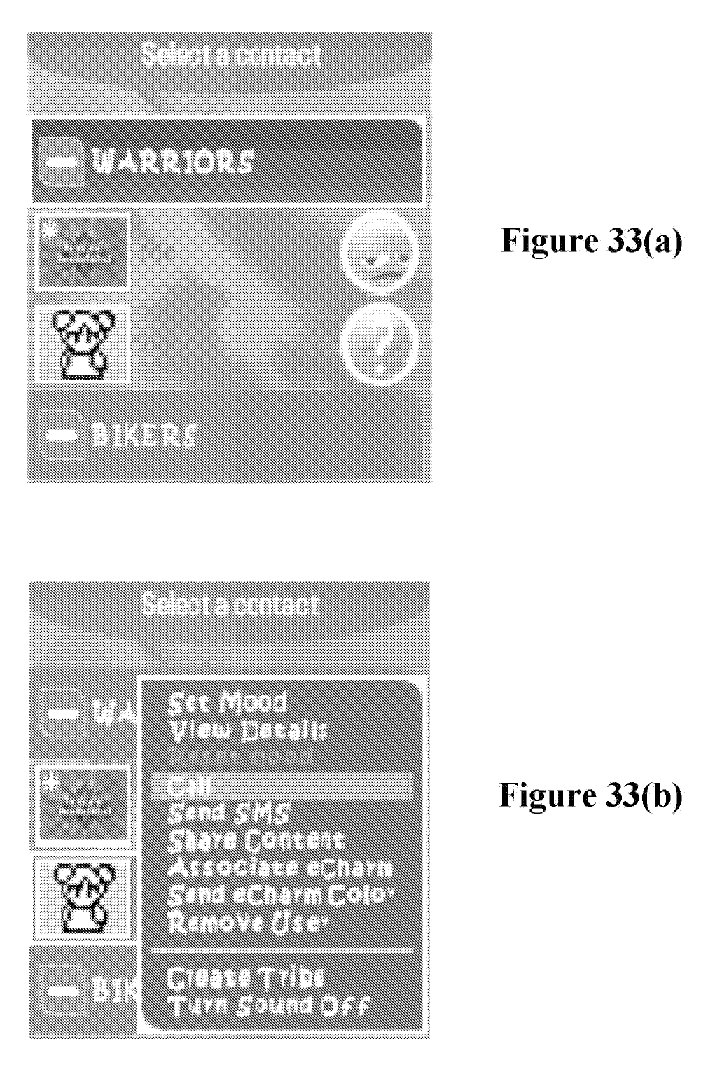

FIGS. 33 (a)-(b) show examples of interfaces through which a user can change the mood that appears on another phone by calling that other phone, according to some embodiments. Upon calling the other phone, the user can notice that the ring tone and logo changed on the other phone. Note that the other phone does not need to be running the software that facilitates the disclosed telephone personalization system and methods when the user calls the other phone.

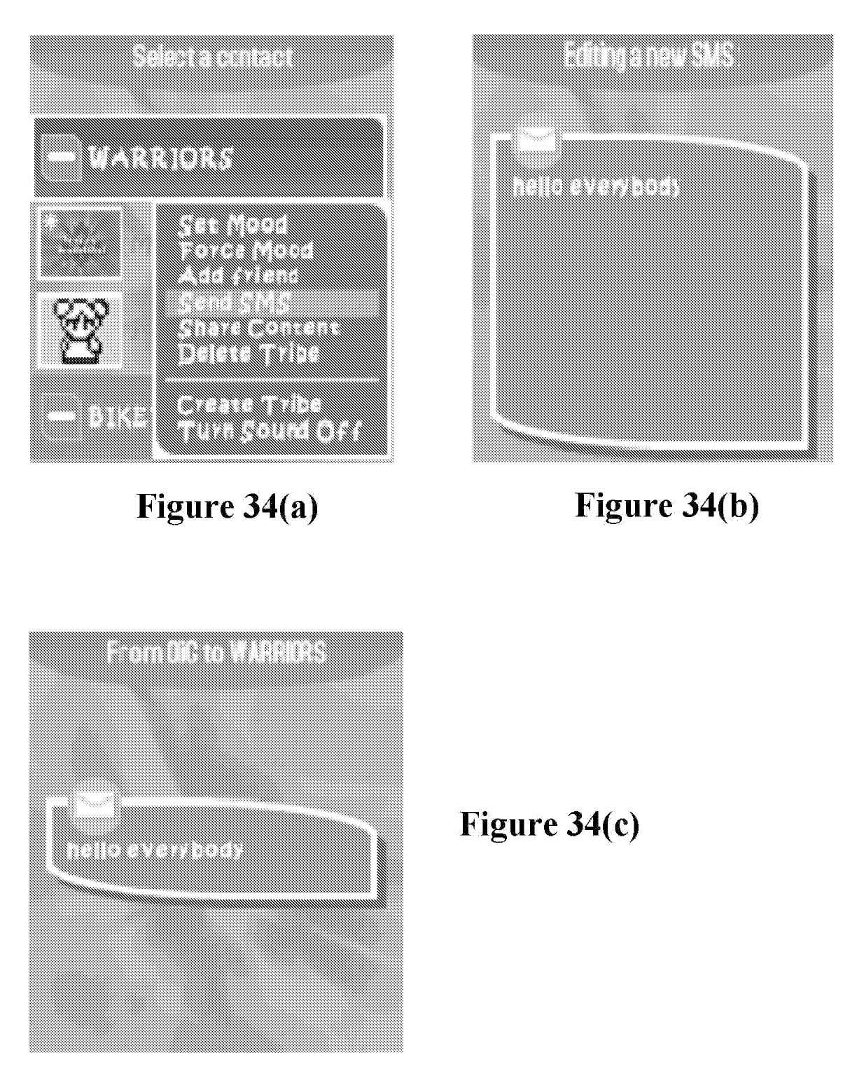

FIGS. 34 (a)-(c) show examples of interfaces through which a user can broadcast an SMS to all the contacts in a tribe. The user may highlight a tribe, select the item “Send SMS,” type the message, and send it when finished. The other phones will receive the SMS and display an alert box to display the message.

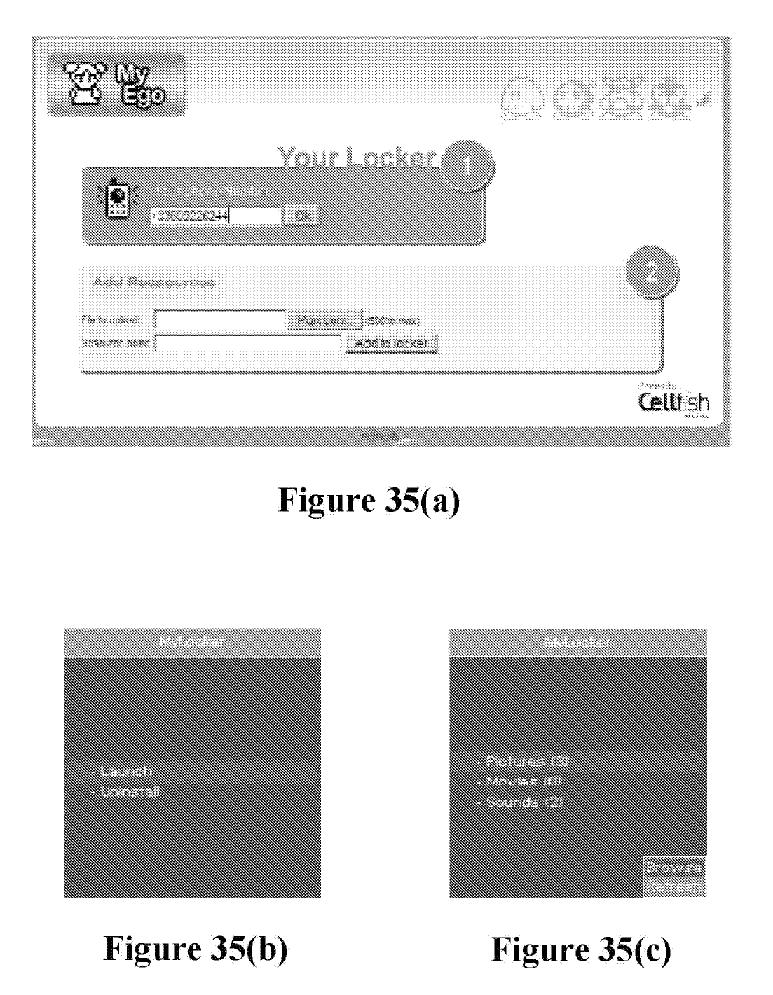

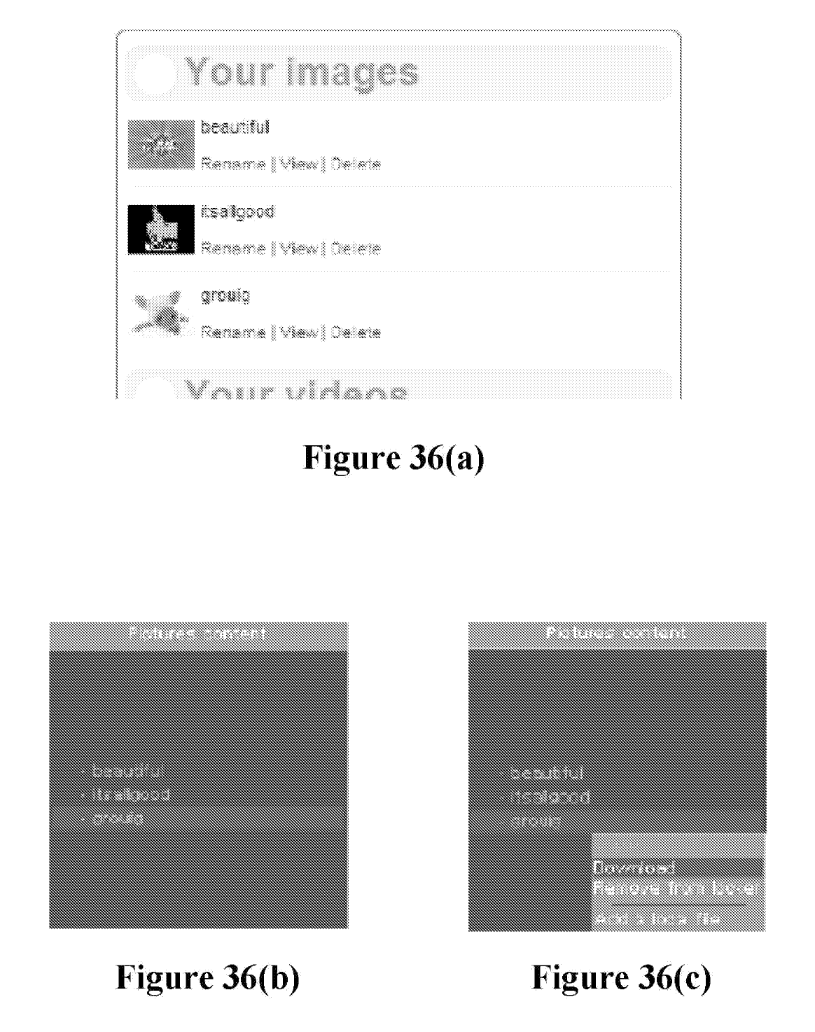

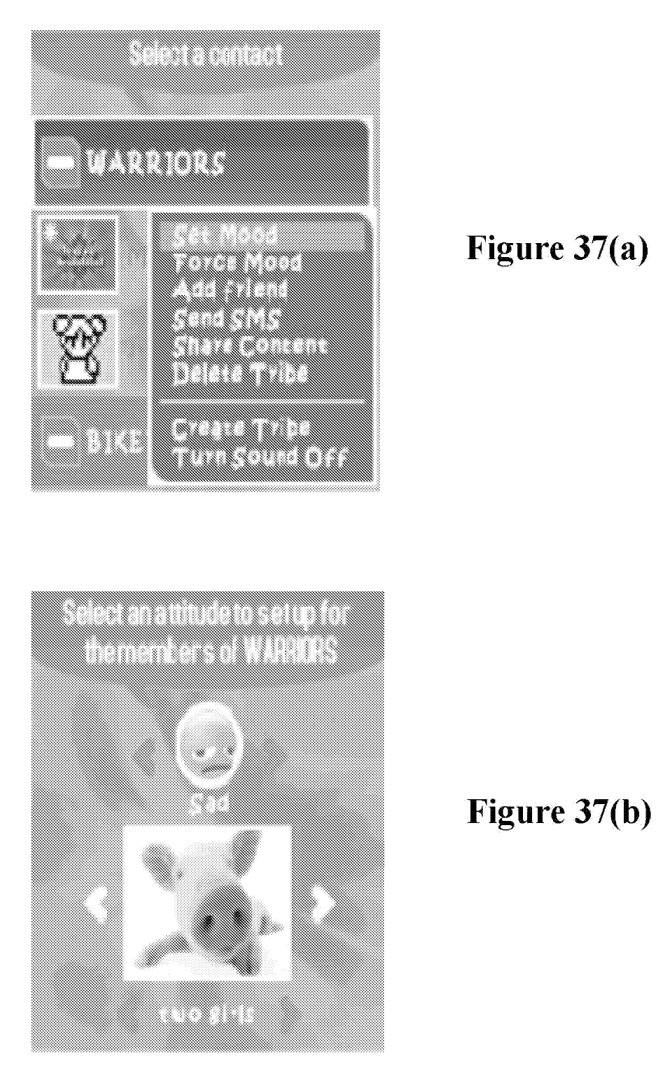

FIGS. 35 (a)-(c) show examples of interfaces through which a user can add new content for use with personalization of the user's cellular telephone. Through a web browser, the user can select content from a computer. The user may also add a sound. The file may include, but is not limited to, a midi or a MP3 file. The user may launch the locker on the handset in order to synchronize the content with the locker on the web. FIGS. 36 (a)-(c) show examples of interfaces through which a user can see that the content of the handset's locker matches the content of the locker on the web. The user can then see the new content that is available for use with personalization of the user's cellular telephone, as shown in FIGS. 37 (a)-(b). When the user browses through the pictures or sounds, the user can see the new material added.

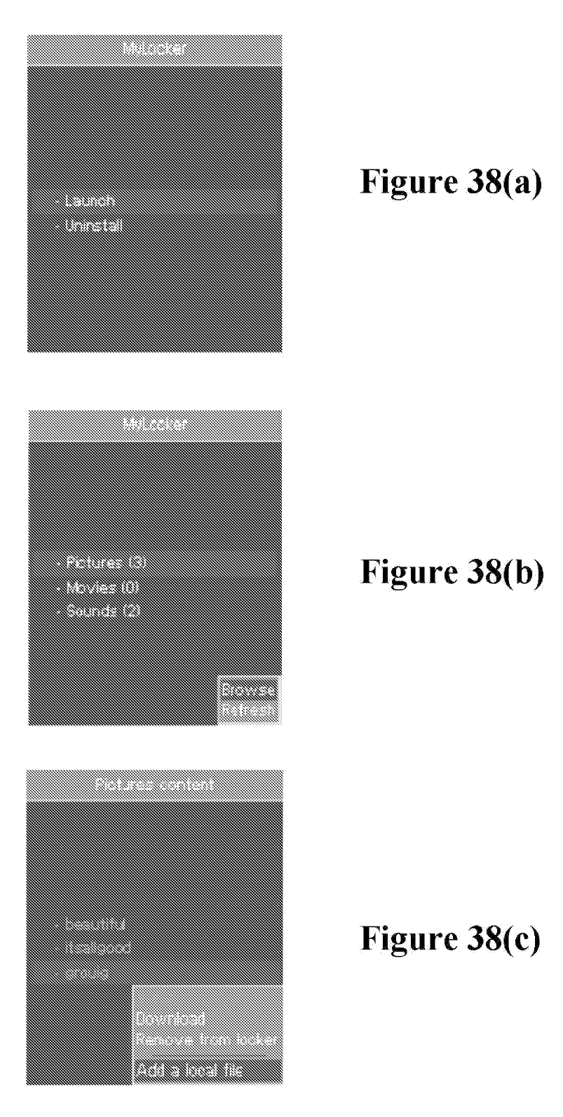

FIGS. 38 (a)-(c) show examples of interfaces through which a user can add user generated content for use with personalization of the user's cellular telephone. After taking a picture using the regular phone camera application, the user may add the picture to the user's locker. The picture may then be used with personalization of the user's cellular telephone.

Reference will now be made to embodiments of a mobile telephone personalization system in accordance to the present invention, as illustrated by FIGS. 39-49. In such embodiments, a user may choose a desired image and/or ringtone that the user wants to appear on a friend's phone when the user calls the friend. In certain embodiments, a user may give the user's friends control of what image and ringtone will appear on the user's phone when the user's friends call the user. By personalization such mobile communications, an unique social experience is established between users.

As shown in FIG. 39, users may access the personalization system via interfaces including, but not limited to, a mobile interface 391 and a web interface 392. Through such interfaces, a user may choose a desired image/ringtone for a friend's phone and/or allow the user's friends to control their desired image/ringtone for the user's phone.

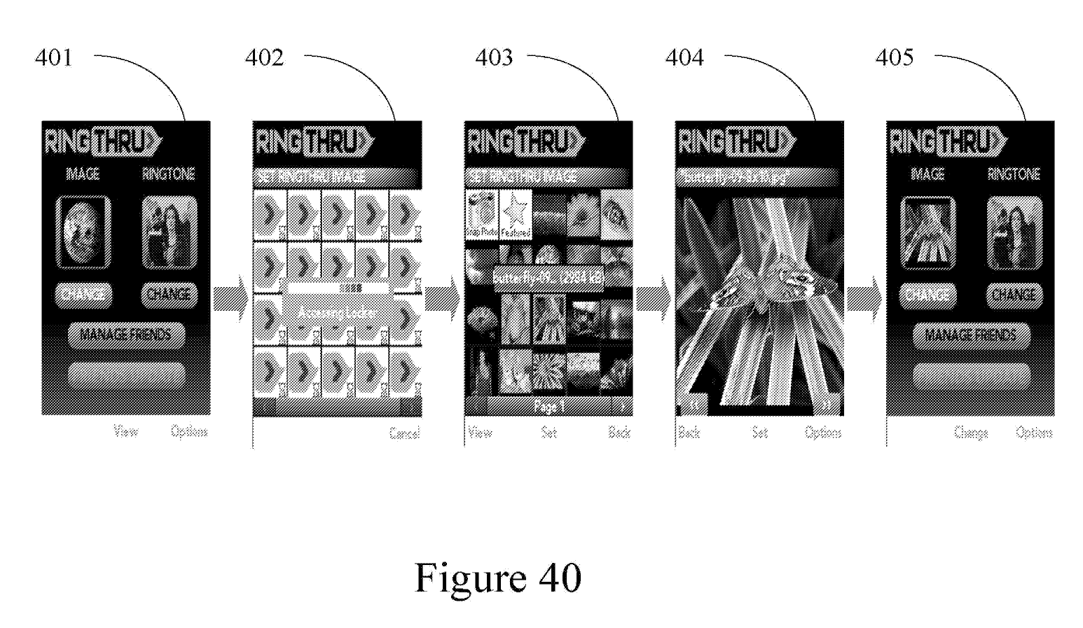

In some embodiments, these interfaces provide various ways for users to choose the images for their friends to see when such friends are called. A user may select the content stored in the user's mobile online locker. Such a mobile locker may store digital media that the user uploaded from the web or from the mobile application. As shown in FIG. 40, a user may change an image as follows: initiate a change 401, access content from a mobile locker 402; select a new image and/or view it larger 403; set the new image 404; and update the new image for the mobile and the web interface 405. In another embodiment, a user may have the ability to capture a picture on the user's handset and use it as the image to be shared with friends. In some embodiments, the user may have the ability to access new content via other networks, such as the Internet.

The ringtone may also changed in various ways according to different embodiments. A user may select content from a personal mobile locker. Also, a user may have the ability to capture a voice recording and use it as the ringtone. Further, a user may be able to access new content via a network.

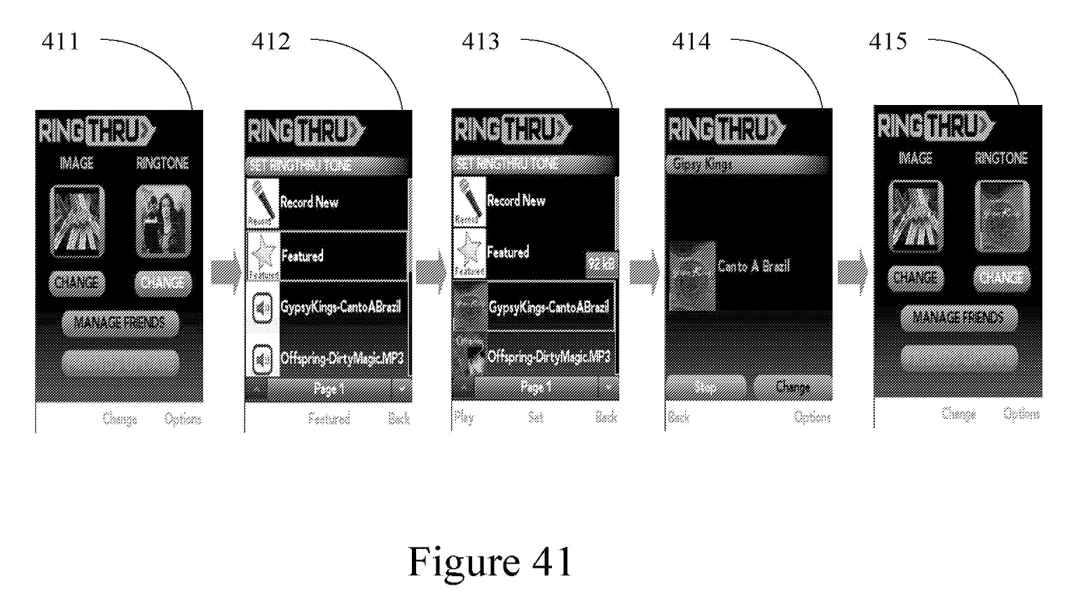

FIG. 41 shows embodiments of the interfaces through which a user can change the ringtone that user's friends will hear when the user calls them. The ringtone may be changed as follows: initiate a change 411, access content from a mobile locker 412; select a sound file to play 413; listen to the sound file and set it as your new tone/ringer 414; and update the new tone for the mobile and the web interface 415.

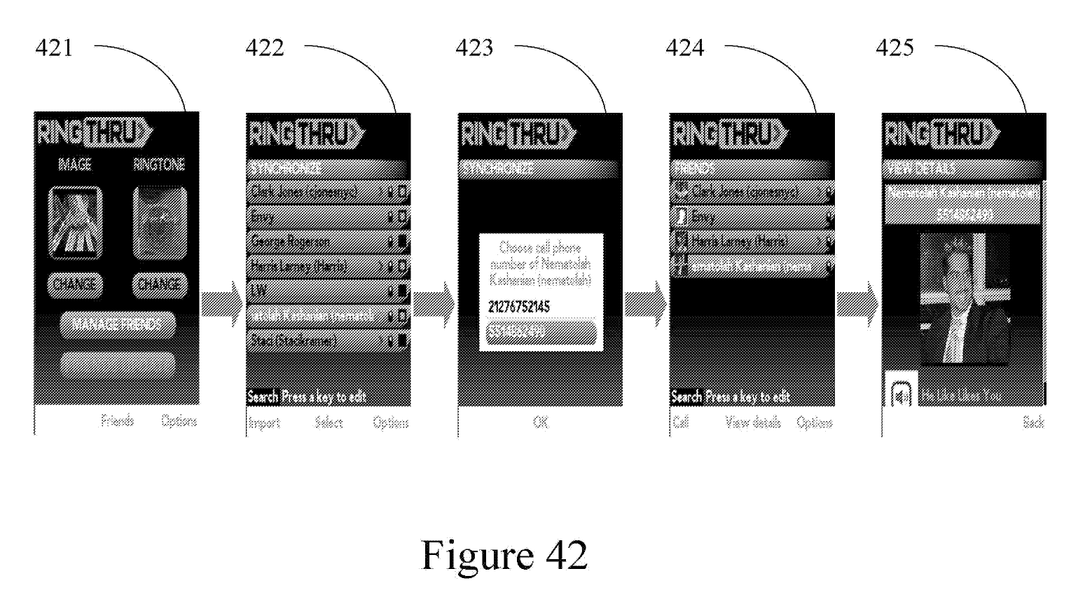

In some embodiments, as illustrated in FIG. 42, a user can populate user's friends list from contacts in the phonebook of the user's handset. In the alternative, the user's friends list may be populated from the recent-calls log of the user's handset. These may be the friends who will be able to see the user's image and ringtone when the user calls them. In addition, these friends may be permitted to set an image and ringtone on the user's phone for when they call the user. Users may select their friends through the interface 421. Users may add friends from the user's handset phonebook through the interface 422. Users may later go back to the friends list and import new contacts from the user's phonebook or delete friends from the user's current friends list. Friends who are current members may have an icon and/or username displayed next to their phonebook name. User may select the proper number from the phonebook through the interface 423. Friends that are not yet members may be sent an invitation to sign up and become a member via a website. Users may import contacts from the user's phonebook to the user's friends list via the interface 424. A user may use the friends list to make calls to the user's friends directly from the application. Users may view their friends' images and play their ringtones through the interface 425. This is the image and ringtone that a user would hear when the user's friend calls the user.

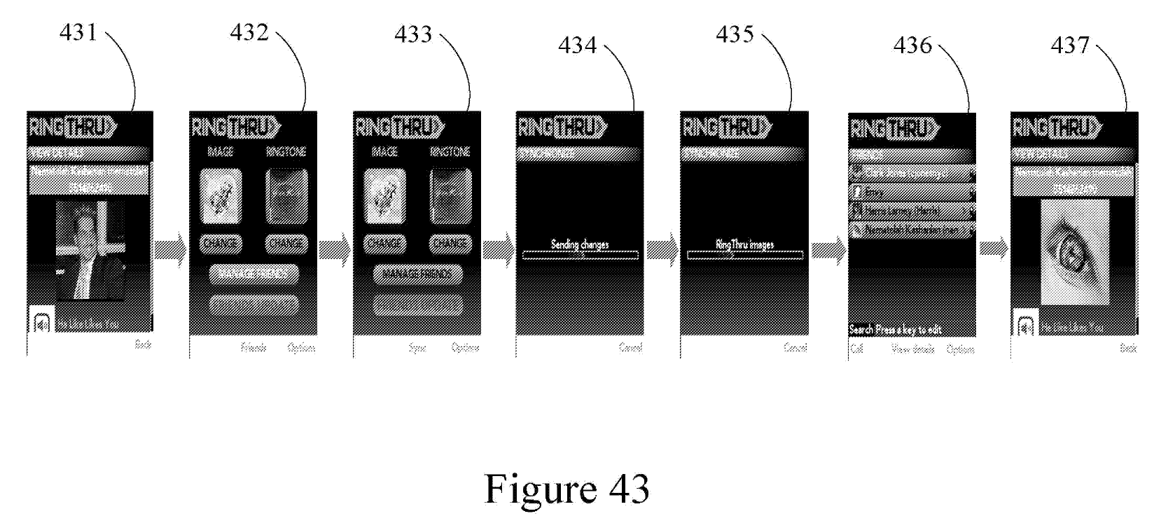

In some embodiments, when a user's friend updates the image and/or tone from the mobile application or the internet, the application will be notified to update the friend's contact information. FIG. 43 shows such an embodiment implemented through the following interfaces wherein the mobile application: displays the current image/tone for friend 431; notifies that friend updated image/tone 432; selects friend's update option to download friend's new image/tone 433; finds all of friend's changes and starts the syncing processes 434; downloads the new image/tone that are available and sets them in user's phonebook 435; updates friend's list with the new image/tone 436; and displays the new image/tone that will be seen and heard when friend calls user 437.

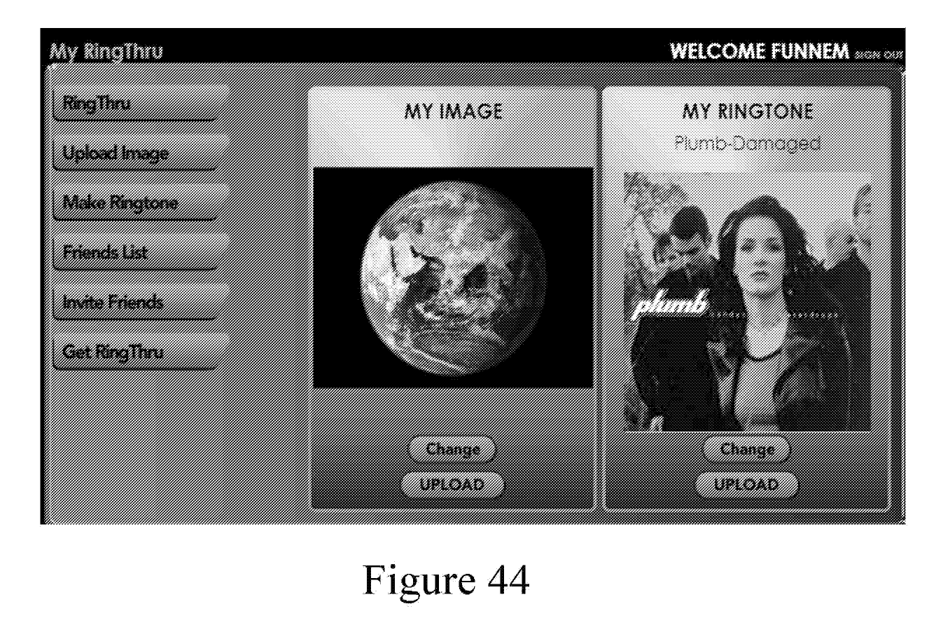

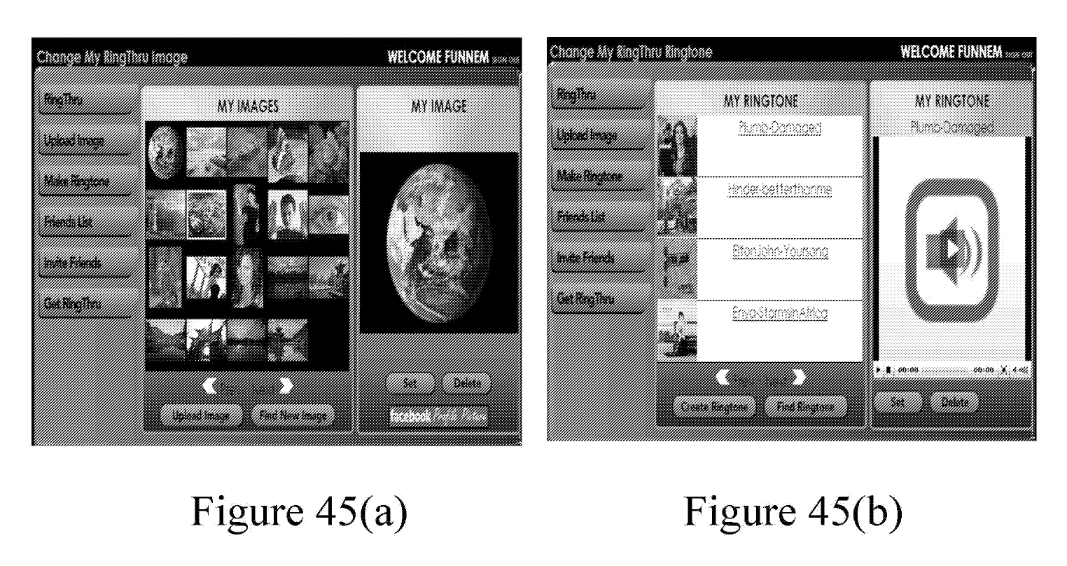

As shown in FIG. 44, certain embodiments provide for a website that may allow users to access their image/tone online by connecting the web and handset together seamlessly. Such a website may allow users to change their images and ringtones online through interfaces, as shown in FIGS. 45 (a) and (b), respectively. As with the mobile application, this website may allow the user to upload new images/tones or find images/tones from a special featured catalog, as well as allow the user to create their own images/tones. In some embodiments, a social networking option may allow the user to pull profile pictures from Facebook, Flickr, and Picasa web sites. Other such sites may also be added in the future.

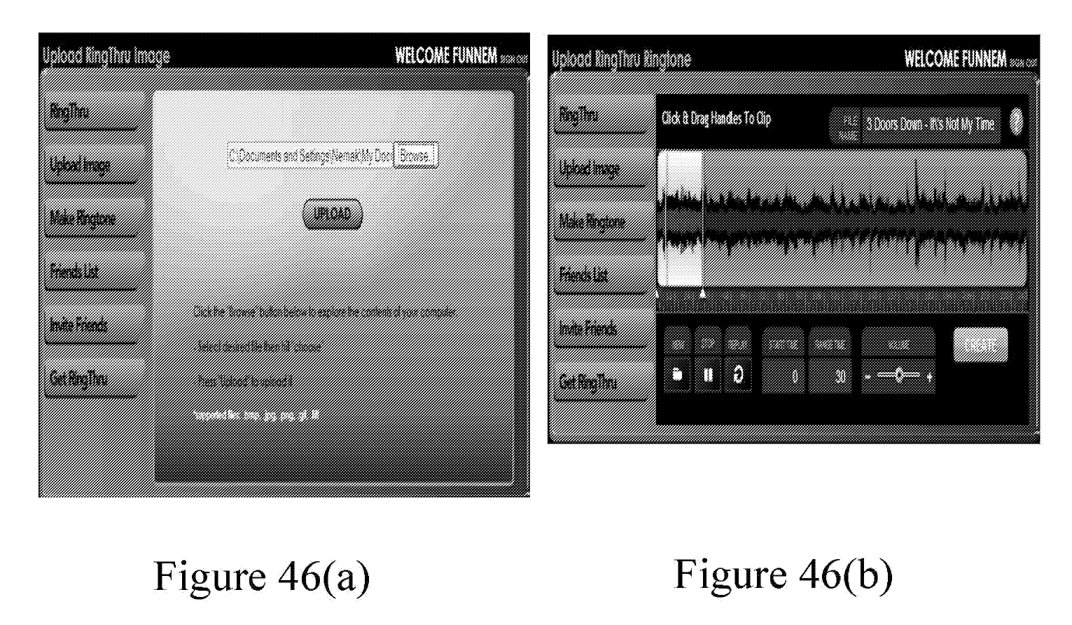

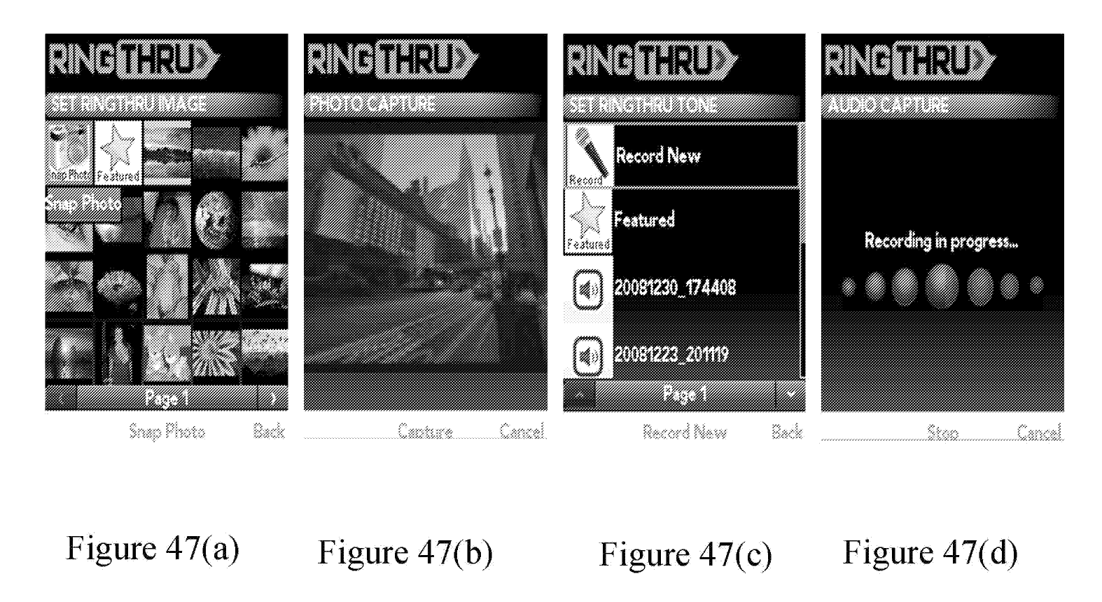

As depicted in FIGS. 46 (a) and (b), embodiments may include interfaces through which a user can upload an image from a personal computer (PC) and/or create a ringtone from one of the user's music files via the ringtone maker. FIGS. 47 (a)-(b) show examples of interfaces through which users may take pictures from their phones in order to use them as their images. FIGS. 47 (c)-(d) show examples of interfaces through which users may record sound files in order to use them as their tones.

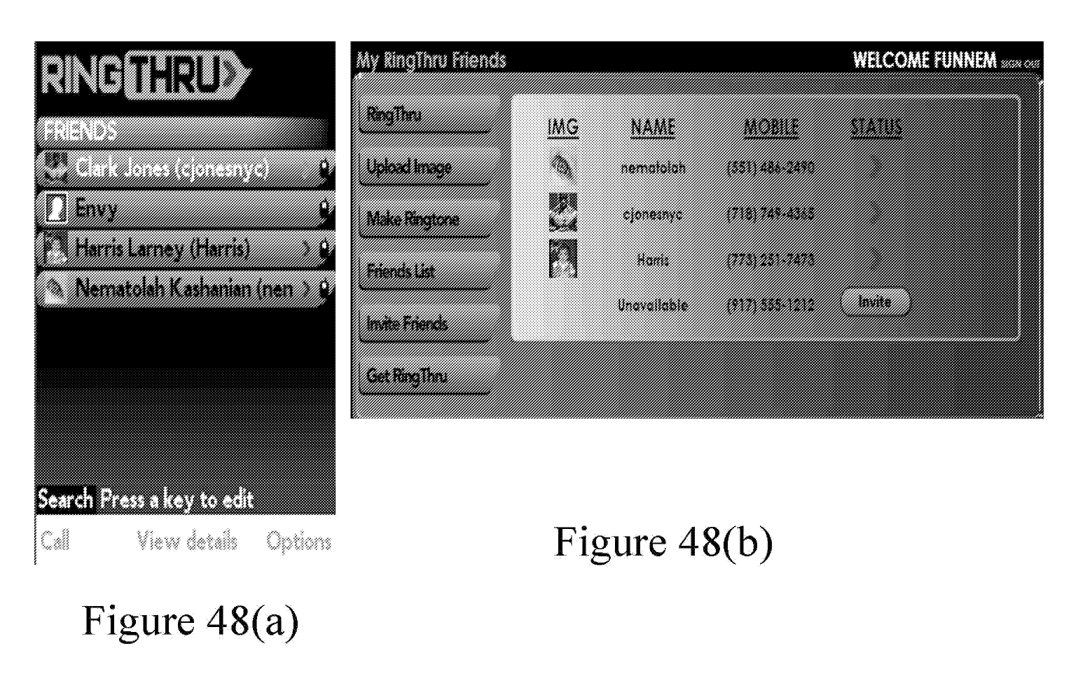

In certain embodiments, the website and mobile application may be seamlessly linked so that a user may see their friends' list images and ringtones. FIGS. 48 (a) and (b) show examples of such interfaces in the mobile application and website, respectively. A users that does not have the mobile application may use the website to customize what image and ringtone their friends will hear when the user calls them.

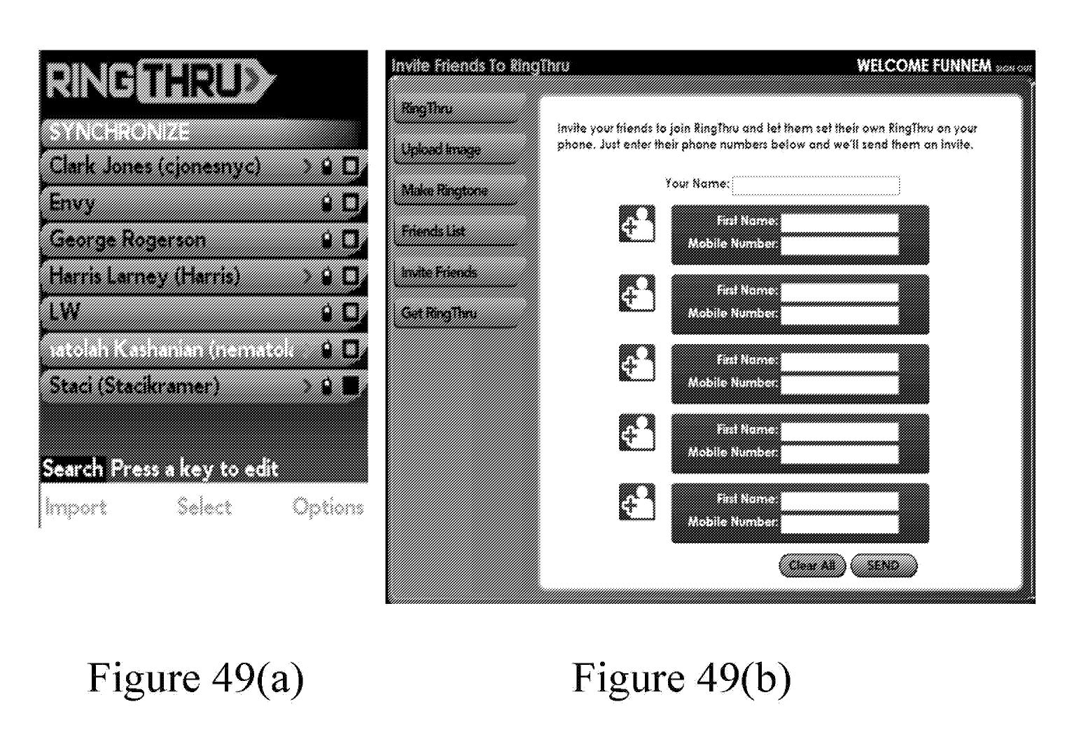

Furthermore, in certain embodiments, the website and mobile application may allow a user to invite the user's friends to use the disclosed system if the friend is not already an member, as shown in the examples of interfaces illustrated in FIGS. 49 (a) and (b). As such, all of the user's friends may customize and personalize their ringtones and images on the user's phone for the user to see and hear when such friends call the user.

Through the personalization system and methods described herein, a user can create social networks and project information to members of such social networks; easily distribute SMS, E-mail, or other messages to members of such social networks; and even project mood information to individual contacts. While detailed and specific embodiments of the personalization system and methods have been described herein, it will be apparent to those skilled in the art that various changes and modifications can be made therein without departing from the spirit and scope of the personalization system and methods. Thus, it is intended that the present disclosure cover these modifications and variations provided they come within the scope of any appended claims and/or their equivalents.

What is claimed is:

1. A method of projecting information from a first user from a first device associated with the first user to at least one device associated with a first group of friends, comprising:
receiving from the first user a first set of contacts, wherein each contact in the first set of contacts has device contact information associated therewith;
storing the first set of contacts in the first device associated with the first user;
permitting the first user to define the first group of friends, wherein the first group of friends comprises members of the first set of contacts;
storing the first group of friends; and,
receiving from the first user personal media to be projected to the first group of friends, the personal media being stored in a file locker.

2. The method of claim 1, further comprising:
retrieving the device contact information from the first set of contacts for each member of the first group of friends; and,
transmitting the personal media from the file locker to the first group of friends.

3. The method of claim 2, further comprising:
receiving from at least one device associated with the first group of friends a confirmation that the personal media has been received.

4. The method of claim 1, the first device comprising a web-enabled device.

5. The method of claim 1, the first device comprising a cellular telephone.

6. The method of claim 1, wherein at least one device associated with the first group of friends comprises of a web-enabled device.

7. The method of claim 1, wherein at least one device associated with the first group of friends comprises of a cellular telephone.

8. The method of claim 1, the device contact information comprising a telephone number.

9. The method of claim 1, the device contact information comprising a Uniform Resource Locator.

10. The method of claim 1, the device contact information comprising a network address.

11. The method of claim 10, the network address comprising an Internet Protocol address.

12. The method of claim 1, the personal media comprising a picture.

13. The method of claim 1, the personal media comprising a video.

14. The method of claim 1, the personal media comprising a ring tone.

15. The method of claim 1, further comprising associating the personal media with the first user within at least one device associated with the first group of friends.

16. The method of claim 1, further comprising synchronizing the personal media with a contact list within at least one device associated with the first group of friends.

17. The method of claim 1, further comprising synchronizing the personal media with an address book within at least one device associated with the first group of friends.

18. The method of claim 2, further comprising of presenting the personal media within at least one device associated with the first group of friends upon being contacted by the first user.

19. The method of claim 1, further comprising identifying as a second device any device associated with a member of the first group of friends that is not capable of utilizing the personal media and facilitating the installation of software on the second device such that the second device is capable of utilizing the information.

20. The method of claim 1, the first group of friends are stored remotely from the first device.

21. A method of projecting information from a first user from a first device associated with the first user to at least one device associated with a first group of friends, comprising:
receiving from the first user a first set of contacts, wherein each contact in the first set of contacts has device contact information associated therewith;
storing the first set of contacts in the first device associated with the first user;
permitting the first user to define the first group of friends, wherein the first group of friends comprises members of the first set of contacts;
storing the first group of friends on a client server;
receiving from the first user personal media to be projected to the first group of friends, the personal media being stored in a file locker, the file locker located on the client server;
retrieving the device contact information from the first set of contacts for each member of the first group of friends; and,
transmitting the personal media from the file locker to the first group of friends.

22. The method of claim 21, further comprising:
receiving from at least one device associated with the first group of friends a confirmation that the personal media has been received.

23. The method of claim 21, further comprising identifying as a second device any device associated with a member of the first group of friends that is not capable of utilizing the personal media and facilitating the installation of software on the second device such that the second device is capable of utilizing the information.

24. The method of claim 21, further comprising associating the personal media with the first user within at least one device associated with the first group of friends.

25. The method of claim 21, further comprising synchronizing the personal media with a contact list within at least one device associated with the first group of friends.

26. The method of claim 21, further comprising synchronizing the personal media with an address book within at least one device associated with the first group of friends.

27. The method of claim 21, the first device comprising a web-enabled device.

28. The method of claim 21, the first device comprising a cellular telephone.

29. The method of claim 21, wherein at least one device associated with the first group of friends comprises of a web-enabled device.

30. The method of claim 21, wherein at least one device associated with the first group of friends comprises of a cellular telephone.

31. A method of projecting information onto devices, comprising:
receiving user information and a plurality of contacts, wherein the user information and the plurality of contacts are received from a user via a network, wherein the user information has user device information associated with the user, and wherein each contact of the plurality of contacts has device contact information associated therewith;
storing the user information and the plurality of contacts in a database, wherein the database is accessible to the network;
distributing the user information to a plurality of devices via the network, wherein the plurality of devices are identified by the corresponding device contact information associated with the plurality of contacts; and,
storing the user information in the plurality of devices.

32. The method of claim 31, further comprising:
distributing media content to the plurality of devices;
storing the media content in the plurality of devices; and,
associating the media content with the user within the plurality of devices.

33. The method of claim 32, wherein the media content comprises at least one media content selected from the group consisting of: an image, a video, an avatar, or a ring tone.

34. The method of claim 31, wherein the user information includes media information associated with the user.

35. The method of claim 34, wherein the media information is associated to the user within the plurality of devices.

36. The method of claim 34, wherein the media information is an alert that notifies one of the plurality of devices of an incoming communications from the user.

37. The method of claim 34, wherein the media information is associated to at least one media content selected from the group consisting of: an image, a video, an avatar, or a ring tone.

38. The method of claim 37, wherein the media content is stored on the plurality of devices.

39. The method of claim 37, wherein the media content is accessible via the network.

40. The method of claim 37, further comprising:
distributing the media content to the plurality of devices;
storing the media content in the plurality of devices.

41. The method of claim 31, further comprising associating the media content with the user within the plurality of devices.

42. The method of claim 31, further comprising synchronizing the media content with the plurality of contacts.

43. The method of claim 31, further comprising synchronizing the media content with an address book.

44. The method of claim 31, wherein at least one of the plurality of devices are web-enabled devices.

45. The method of claim 31, wherein at least one of the plurality of devices are cellular telephones.

46. A system for projecting information onto devices, comprising:
user information and a plurality of contacts received from a user via a network, wherein the user information has user device information associated with the user, and wherein each contact of the plurality of contacts has device contact information associated therewith;
a database accessible to the network, wherein the user information and the plurality of contacts are stored in the database; and,
a plurality of devices accessible via the network, wherein the plurality of devices are identified by the corresponding device contact information associated with the plurality of contacts, and wherein the user information is distributed to the plurality of devices and stored therein.

47. The system of claim 46, further comprising:
media content accessible to the network, wherein the media content is distributed to the plurality of devices.

48. The system of claim 47, wherein the media content is associated with the user within the plurality of devices.

49. The system of claim 47, wherein the media content is synchronized with the plurality of contacts.

50. The system of claim 47, wherein the media content is synchronized with an address book.

51. The system of claim 47, wherein at least one of the plurality of devices are web-enabled devices.

52. The system of claim 47, wherein at least one of the plurality of devices are cellular telephones.

53. A method of receiving information from a friend associated with a user, comprising:
permitting the friend to transmit media, wherein the media is to be projected on a device associated with the user;
receiving from the user a request to transmit the media;
permitting the friend to select personal media;
selecting the personal media to be transmitted; and
receiving the personal media from a device associated with the friend.

54. The method of claim 53, further comprising:
storing the personal media in a file locker.

55. The method of claim 54, further comprising:
transmitting the personal media from the file locker to the device associated with the user.

56. The method of claim 53, further comprising:
projecting the personal media on the device associated with the user.

57. The method of claim 53, further comprising:
associating the personal media with the friend on the device associated with the user.

58. The method of claim 53, further comprising:
synchronizing the personal media with an address book within the device associated with the user.

59. The method of claim 53, the device associated with the user comprising a web-enabled device.

60. The method of claim 53, the device associated with the user comprising a cellular telephone.
